(19) United States
(12) Patent Application Publication
(10) Pub. No.: US 2025/0083375 A1
(43) Pub. Date: Mar. 13, 2025

(54) SUSTAINABLE 3D PRINTING BY REVERSIBLE SALTING-OUT EFFECTS WITH AQUEOUS SALT SOLUTIONS

(71) Applicant: The Regents of the University of California, Oakland, CA (US)

(72) Inventors: Jinhye Bae, San Diego, CA (US); Eng Ann Joseph Liu, San Francisco, CA (US); Donghwan Ji, La Jolla, CA (US)

(21) Appl. No.: 18/827,434

(22) Filed: Sep. 6, 2024

Related U.S. Application Data
(60) Provisional application No. 63/581,567, filed on Sep. 8, 2023.

(51) Int. Cl. B29C 64/106; B29C 64/188; B29C 64/40; B29K 77/00; B29K 507/04

(52) U.S. Cl. CPC B29C 64/106; B29C 64/188; B29C 64/40; B29K 2077/00; B29K 2507/04

(57) ABSTRACT

A method may place a polymer solution comprising a polymer susceptible to solidification due to salting-out effects into contact with a salt solution. A method may induce solidification of the polymer through salting-out effects. A method may remove the solidified polymer from the salt solution.

### CROSS-REFERENCE TO RELATED APPLICATION

This application claims the benefit of priority to U.S. Provisional Patent Application Ser. No. 63/581,567 entitled “SUSTAINABLE 3D PRINTING BY REVERSIBLE SALTING-OUT EFFECTS WITH SALT SOLUTIONS,” filed Sep. 8, 2023, the disclosure of which is incorporated herein in its entirety by reference.

### BACKGROUND

Additive manufacturing, also known as 3D printing, is a manufacturing process that creates three-dimensional objects by depositing materials layer by layer. This process typically involves using digital 3D models to guide the fabrication of objects through the successive addition of material. Various materials can be used in additive manufacturing, including plastics, metals, ceramics, and even biological materials. The specific technique and material used can vary depending on the application and desired properties of the final product. Additive manufacturing offers several advantages over traditional manufacturing methods, including the ability to create complex geometries, reduce material waste, and enable rapid prototyping and customization of parts. However, current additive manufacturing methods often rely on energy-intensive processes or environmentally harmful materials, creating a need for more sustainable approaches that can maintain the benefits of additive manufacturing while reducing its environmental impact.

### SUMMARY OF THE INVENTION

In some aspects, the techniques described herein relate to a method for additive manufacturing, including: placing a polymer solution including a polymer susceptible to solidification due to salting-out effects into contact with a salt solution; inducing solidification of the polymer through salting-out effects; and removing the solidified polymer from the salt solution.

### BRIEF DESCRIPTION OF THE FIGURES

The drawings illustrate generally, by way of example, but not by way of limitation, various aspects of the present invention.

FIGS. 1A-1H are a series of schematics, images and graphs showing the salting-out effect on phase transition of PNIPAM-based solution. FIG. 1A shows phase transition caused by temperature changes. FIG. 1B shows the PNIPAM solution in the coil state below LCST and solidified PNIPAM in the globule state above LCST. FIG. 1C shows phase transition caused by the salting-out effect. FIG. 1D shows the solidified PNIPAM within 2M CaCl₂ solution or 4M CaCl₂ solution, respectively, and their reversible phase transition to the coil state at subzero temperatures. FIG. 1E shows the re-solidification of the reversibly liquified PNIPAM within 4M CaCl₂ solution. Before warming up the liquified solution in the coil state, it was agitated to fully disperse the PNIPAM into the CaCl₂ solution. FIG. 1F shows the solidification of PNIPAM solution by various salt solutions, such as 2M NaCl, 2M AlCl₃, 2M LiCl, and 2M ZnBr₂. FIG. 1G shows the cross-sectional SEM images of PNIPAM before after the phase transition caused by 2M Cal₂ solution. FIG. 1F shows FTIR patterns of PNIPAM solution and two different PNIPAM solidified by heating or 2M CaCl₂, respectively.

FIGS. 2A-2E are a series of graphs showing the phase transition temperatures differed by salt ion conditions. FIG. 2A shows storage moduli change of 1M PNIPAM under different CaCl₂ concentrations over the temperature increase. FIG. 2B shows storage moduli change of PNIPAM with a different concentration at the 3M CaCl₂ condition over the temperature increase. FIG. 2C shows repetitive heating and cooling of 1M PNIPAM at the 3M CaCl₂ condition. FIG. 2D shows storage moduli change of 1M PNIPAM within a salt solution of different salt types, 3M NaCl, CaCl₂, or AlCl₃. FIG. 2E shows the overall phase transition temperature, LCST, of 1M PNIPAM at different salt ions and different ion concentrations.

FIGS. 3A-3Q are a series of schematics, images and graphs showing the instant solidification of PNIPAM-based solutions by reversible physical crosslinking. FIG. 3A shows extrusion and solidification of pure PNIPAM solution in 3M CaCl₂ solution. FIG. 3B shows storage (G′) and loss moduli (G″) changes of PNIPAM solution by adding 2-4M CaCl₂ solutions. FIG. 3C shows dissolution of solidified PNIPAM in water. FIGS. 3D-3I show extrusion and solidification of PNIPAM-based composite solutions, PNIPAM/Dye, PNIPAM/MXene, PNIPAM/CNT, PNIPAM/PVA, PNIPAM/PAM, and PNIPAM/Alg in the CaCl₂ solution, respectively. FIG. 3J shows solidified PNIPAM/MXene composite displaying freestanding behavior. FIG. 3K shows schematic depicting the rapid confinement of particles among the aggregated PNIPAM chains. FIG. 3L shows storage modulus increase of PNIPAM and PNIPAM composite solutions upon the solidification by 3M CaCl₂. FIG. 3M shows conductivity of pure PNIPAM and PNIPAM/MXene+CNT composite solidified by 3M CaCl₂ (n=4). Error bars correspond to standard deviations. FIG. 3N shows solidified PNIPAM/PVA composite showing deformable and stretchable behaviors. FIG. 30 shows a schematic illustrating the entangled polymer chains. FIG. 3P shows a tensile stress-strain curve and FIG. 3Q shows the corresponding tensile strength and elastic modulus of the solidified PNIPAM/PVA in a filament form (n=5). Error bars correspond to standard deviations.

FIGS. 4A-4F are a series of graphs showing rheological characteristics of PNIPAM-based solutions. FIG. 4A shows viscosity as a function of shear rate for pure PNIPAM solutions with different concentrations and FIGS. 4B-4C show 1M PNIPAM-based composite solutions containing functional materials or other polymers, respectively. Storage (G′) and loss moduli (G″) as a function of angular frequency for pure PNIPAM solutions with different concentrations and PNIPAM-based composite solutions, shown in FIG. 4D and FIGS. 4E-4F, respectively. Error bars correspond to standard deviations at n≥3.

FIGS. 5A-5G are a series of schematics and images showing sustainable 3D printing utilizing reversible salting-out effects and its potential applications. FIG. 5A shows printing of PNIPAM-based ink solution onto a substrate wetted by a salt solution for spontaneous and rapid solidification. The right printed structure has approximately ten layers along the Z axis. FIG. 5B shows embedded printing of PNIPAM-based solution ink in a support bath comprising Pluronic F-127 and CaCl₂. FIG. 5C contains side and top view photographs displaying two different solidified PNIPAM/PVA structures with different sizes printed in the middle of the bath. FIG. 5D shows the entire recycling process of the printed PNIPAM structure: dissolution in water, water evaporation, and re-dissolution in water. FIG. 5E shows PNIPAM/CNT-based electrically conductive and water-soluble disposable printed structure. FIG. 5F shows dye-loaded PNIPAM carrier transferring the red dye to the bottom substrate while dissolving in water. FIG. 5G shows self-folding and unfolding multi-stage actuator responding to simple environmental changes in salt concentrations.

FIG. 6 is a graph showing the XRD pattern of NIPAM, PNIPAM, NaCl, and solidified PNIPAM by NaCl, respectively. Once NIPAM dry solid powder dissolved and polymerized, the PNIPAM was in an amorphous state. The PNIPAM solidified by NaCl was also amorphous, whose XRD pattern was similar to that of the PNIPAM. The sharp peaks observed in the solidified PNIPAM sample were from NaCl crystals.

FIGS. 7A-7B are two graphs showing the shift in phase transition temperature, LCST, at different salt ions and their concentrations. FIG. 7A shows storage moduli change of 1 M PNIPAM under different NaCl concentrations, over the temperature increase. FIG. 7B shows storage moduli change of 1 M PNIPAM under different AlCl₃ concentrations, over the temperature increase. The PNIPAM solidified within a 4 M AlCl₃ solution was not fully dissolved on the rheometer stage of −20° C. which was the minimum setting-temperature of the rheometer.

FIGS. 8A-8E are a series of images showing water-dissolution processes of solidified PNIPAM-based composite over time. PNIPAM/Dye, PNIPAM/MXene, PNIPAM/CNT, PNIPAM/PVA, and PNIPAM/PAM composite systems, which solidified in 3M CaCl₂ solution, all became fully dissolved in water (shown in FIGS. 8A-8E, respectively), similar to pure PNIPAM.

FIGS. 9A-9C are a series of schematics, images and graphs showing PNIPAM/Alg composite forming interpenetrating polymer networks. FIG. 9A contains a schematic depicting the formation of interpenetrating polymer networks comprising aggregated and physically crosslinked PNIPAM chains and Ca2+-crosslinked Alg networks. FIG. 9B shows solidified PNIPAM/Alg in 3M CaCl₂ solution and its stability in water. FIG. 9C shows FTIR patterns of PNIPAM crosslinked by CaCl₂, Alg crosslinked by CaCl₂ and thoroughly washed in water, and PNIPAM/Alg crosslinked by CaCl₂ and thoroughly washed in water. These FTIR patterns were collected by measuring samples dried at 25° C.

FIGS. 10A-10B are a series of images showing the solidification of PNIPAM-based composite solutions in other salt solutions. FIG. 10A shows a 3M NaCl solution. FIG. 10B shows a 3M AlCl₃ solution.

FIG. 11 shows a schematic and equation for the measurement setup for the conductivity of solidified PNIPAM and PNIPAM/MXene+CNT. To demonstrate the effect of conductive inorganic particles (MXene and CNT) on the conductivity enhancement, pure PNIPAM and PNIPAM/MXene+CNT composite samples were representatively compared. Each solution was extruded into the 3 M CaCl₂ solution, resulting in fully crosslinked and solidified samples. Water on the surface of the solidified samples was gently wiped using Kimtech Wipes, and the sample was placed on the customized measuring device as shown in the schematic illustration.

FIGS. 12A-12B are a series of images showing the finely printed structures of PNIPAM/CNT composite using different nozzle sizes. The structure was printed using a 0.6 mm-diameter nozzle and a 0.25 mm-diameter nozzle, shown in FIGS. 12A and 12B, respectively. This fine and repetitive structure was consistently printed on a cm-scale (4×4 cm²).

FIGS. 13A-13G are a series of schematics, images and graphs showing the printing of PNIPAM/PVA composite solution. FIG. 13A contains photographs showing multi-layer printing of PNIPAM/PVA solution ink with red dye using a 200-μm-diameter nozzle. FIG. 13B shows a photograph of the ten-layer printed grid structure of PNIPAM/PVA. FIG. 13C shows a schematic illustration depicting how we evaluated the adhesion force between the first and the second layers, and the corresponding result is shown in FIG. 13D. FIG. 13E shows a photograph of the three-layer printed structure of PNIPAM/PVA. FIG. 3F shows a tensile stress-strain curve of PNIPAM/PVA structure, demonstrating good physical and mechanical stability with free-standing and stretchable characteristics. FIG. 13G shows G′ and G″ as a function of oscillation shear stress, demonstrating shear-yielding property of PNIPAM/PVA solution.

FIG. 14 contains images showing PNIPAM/CNT structure in the support bath. The printed solution immediately solidified upon contact with the salt ions dissolved in the support bath.

FIGS. 15A-15B are a series of graphs showing rheological characteristics of Pluronic F-127 support bath containing 3 M CaCl₂. FIG. 15A shows G′and G″ as a function of temperature and FIG. 15B shows G′ and G″ as a function of shear stress. The liquid-state mixture was prepared at low temperatures and was a stable solid at ambient temperatures. The solid support bath temporarily became in a fluid-like state while subjected to shear stress (over yield point) generated by the syringe nozzle moving inside the bath.

FIGS. 16A-16B are a series of images showing physically/mechanically stable structures solidified in the support bath. PNIPAM/CNT and PNIPAM/PVA solutions were stably solidified in the bath during vertical and horizontal nozzle movements, as shown in FIGS. 16A and 16B, respectively. The solidified sample was able to be pulled out from the support bath.

FIG. 17 contains a series of images showing recyclability of PNIPAM ink in multiple solidification-dissolution cycles. The solidified PNIPAM in CaCl₂ was quickly rinsed with EtOH and then water to remove excessive salt ions and subsequently re-dissolved in water at a 5° C. refrigerator. The dissolved PNIPAM was loaded into a syringe and extruded into CaCl₂ for the next solidification. Such a series of procedures was repeatable. In the 5th cycle demonstration, we added red dye for better visualization and then printed the shape of a recycle sign.

FIGS. 18A-18C contain a schematic and a series of images showing the conductivity comparison between pure PNIPAM and PNIPAM/CNT composite. FIG. 18A shows the printed and solidified PNIPAM structures (by 3 M CaCl₂), completely dried to remove the effect of ion conduction, were connected to the power supply that applied voltage across the entire circuit. The PNIPAM structures were connected to a bulb linked to the power supply. Copper wires were tightly attached to the PNIPAM structures with copper tape. FIG. 18B shows that pure PNIPAM structure did not make a light bulb work (even at 30 V) due to insufficient conductivity. FIG. 18C shows the PNIPAM/CNT composite structure was able to power a light bulb. The brightness gradually increased with an increase in the applied voltage.

FIG. 19 contains a schematic illustration of the folding actuator structure. The bottom matrix was PNIPAM/nanoclay composite hydrogel and the hinge was L-PNIPAM/alginate composite solution.

FIG. 20 is an image showing the self-folding and unfolding actuator comprising a hinge of PNIPAM/Alg composite solution. The volume contraction caused by crosslinking of PNIPAM/Alg hinge material at the 3M CaCl₂ condition resulted in the folding. Next, the de-crosslinking of the hinge material at 1M NaCl condition released the volume contraction of the hinge, thereby unfolding the actuator in a single stage.

FIG. 21 is a series of images showing the de-crosslinking of solidified Alg with Ca²⁺ crosslinking. The Ca2+-crosslinked Alg was not de-crosslinked and dissolved in water but was able to be de-crosslinked and dissolved in 1M NaCl solution.

FIGS. 22A-22B are a series of cross-sectional SEM images of lyophilized PNIPAM/CNT and PNIPAM/MXene solutions. FIG. 22A shows hydrophobic CNTs with long lengths (5-9 μm according to the manufacturer) were aggregated as denoted as arrows. FIG. 22B shows hydrophilic MXene was homogenously dispersed into the solution. As observed in these cross-sectional SEM images (in lyophilized samples), the internal structure of the PNIPAM/MXene was similar to that of the pure PNIPAM displayed in FIG. 1G.

### DETAILED DESCRIPTION OF THE INVENTION

Reference will now be made in detail to certain aspects of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” or “at least one of A or B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section. A comma can be used as a delimiter or digit group separator to the left or right of a decimal mark; for example, “0.000,1” is equivalent to “0.0001.” All publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

In the methods described herein, the acts can be carried out in any order without departing from the principles of the invention, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%. The term “substantially free of” as used herein can mean having none or having a trivial amount of, such that the amount of material present does not affect the material properties of the composition including the material, such that about 0 wt % to about 5 wt % of the composition is the material, or about 0 wt % to about 1 wt %, or about 5 wt % or less, or less than or equal to about 4.5 wt %, 4, 3.5, 3, 2.5, 2, 1.5, 1, 0.9, 0.8, 0.7, 0.6, 0.5, 0.4, 0.3, 0.2, 0.1, 0.01, or about 0.001 wt % or less, or about 0 wt %.

Various aspects according to the instant disclosure relate to an additive manufacturing method. Additive manufacturing, also known as 3D printing, is a manufacturing process that creates three-dimensional objects by depositing materials layer by layer. This process typically involves using digital 3D models to guide the fabrication of objects through the successive addition of material.

The process generally begins with a computer-aided design (CAD) model, which is then sliced into thin layers. The additive manufacturing machine then builds the object by depositing material according to these layers, with each layer bonding to the previous one. This layering process continues until the entire object is formed.

Various materials can be used in additive manufacturing, including plastics, metals, ceramics, and even biological materials. The specific technique and material used can vary depending on the application and desired properties of the final product.

Additive manufacturing offers several advantages over traditional manufacturing methods, including the ability to create complex geometries, reduce material waste, and enable rapid prototyping and customization of parts.

The instant additive manufacturing method relates more specifically, to a method for using a polymer as a feedstock material and contacting it with an salt solution. The salt solution can be an aqueous salt solution or an organic salt solution (e.g., a solution of a salt and organic solvent such as DMSO). This forms a solidified polymer. The polymer in the polymer solution is chosen from one or more polymers that are susceptible to solidification due to salting-out effects into contact with an salt solution.

The salting out effect is a phenomenon used in polymer science to induce the solidification or precipitation of polymers from solutions. This process involves adding salt to a polymer solution, which alters the solubility of the polymer and causes it to separate from the solution.

When salt is added to a polymer solution, it increases the ionic strength of the solution. This increase in ionic strength disrupts the hydration shell around the polymer molecules. Water molecules that were previously interacting with the polymer chains are now attracted to the salt ions, reducing the solubility of the polymer in the medium.

As the salt concentration increases, the polymer-solvent interactions become less favorable compared to polymer-polymer interactions. This leads to the aggregation of polymer chains and their eventual precipitation or solidification. The effectiveness of the salting out effect depends on various factors, including the type and concentration of salt used, the nature of the polymer, temperature, and pH of the solution.

Examples of polymers that can be used in the polymer solution can include a polyacrylamide, a protein, DNA, or a mixture thereof. Polyacrylates are a diverse family of polymers derived from acrylic acid and its esters. Some common polyacrylates include poly(methyl methacrylate) (PMMA), also known as acrylic glass or Plexiglas, which is widely used in various applications due to its transparency and durability. Poly(acrylic acid) (PAA) is another important polyacrylate, known for its high water absorbency and used in superabsorbent materials. Poly(ethyl acrylate) (PEA) and poly(butyl acrylate) (PBA) are used in adhesives and coatings due to their flexibility and adhesive properties. Poly(2-hydroxyethyl methacrylate) (PHEMA) is utilized in contact lenses and biomedical applications owing to its biocompatibility. Poly(sodium acrylate) is a water-soluble polyacrylate used in detergents and water treatment. Other polyacrylates include poly(tert-butyl acrylate), poly(2-ethylhexyl acrylate), and various copolymers combining different acrylate monomers to achieve specific properties. A polyacrylate that is particularly useful for the instant additive manufacturing method is poly(N-isopropylacrylamide) (PNIPAM) or a PNIPAM-based copolymer.

The molecular weight and structure of the polymer can affect the salting out properties. Higher molecular weight polymers generally exhibit a more pronounced salting out effect due to their larger size and increased number of potential interaction sites. The structure of the polymer, including its hydrophobicity and the presence of charged groups, can also impact its susceptibility to salting out. Polymers with more hydrophobic regions or fewer charged groups tend to be more easily salted out.

Additionally, the concentration of the polymer solution itself can also play a role in the salting out process. Higher polymer concentrations can lead to more rapid and complete precipitation, as there are more polymer chains available for aggregation. However, excessively high concentrations may result in premature gelation or uneven solidification, potentially affecting the quality of the final printed structure.

The polymer solution can include a mixture of different polymers. The polymer can also include a distribution of the same polymer but differing in their respective weight-average molecular weights. Examples of polymers that can be included in the polymer solution, other than polyacrylates, include 1 polyvinyl alcohol, alginate, or a self-healing polymer, a shape memory polymer, an adhesive polymer, or a mixture thereof.

The polymer solution can include other materials such as a therapeutic agent, a self-healing polymer, a shape memory polymer, a surfactant, an antimicrobial particle, a photonic crystal, a magnetic particle, a thermally conductive particle, a pore-forming agent, an acoustic metamaterial, a wetting agent, an adhesive polymer, a lubricant, or a mixture thereof.

Surfactants are compounds that lower the surface tension between two liquids or between a liquid and a solid. A common example is sodium dodecyl sulfate (SDS), widely used in cleaning products and personal care items. SDS has a hydrophilic head and a hydrophobic tail, allowing it to form micelles in water and emulsify oils.

Antimicrobial nanoparticles are nanoscale materials that can kill or inhibit the growth of microorganisms. Silver nanoparticles are a well-known example, often incorporated into textiles, wound dressings, and medical devices for their broad-spectrum antimicrobial activity against bacteria, fungi, and viruses.

Photonic crystals are nanostructured materials that can manipulate light propagation. One example is synthetic opal, composed of silica spheres arranged in a periodic structure. These materials can exhibit structural colors and are used in sensors, displays, and optical communications.

Magnetic particles, such as iron oxide nanoparticles (e.g., magnetite, Fe₃O₄), have applications in magnetic resonance imaging (MRI) contrast agents, targeted drug delivery, and magnetic separation processes. These particles can be manipulated by external magnetic fields and often have superparamagnetic properties at the nanoscale.

Thermally conductive nanoparticles, like boron nitride nanotubes or graphene nanoplatelets, are used to enhance the thermal conductivity of materials. These nanoparticles are incorporated into polymers or composites to improve heat dissipation in electronic devices and thermal management systems. Other conductive nanoparticles can include MXene, a carbon nanotube (CNT), or a mixture thereof.

Pore-forming agents are materials used to create controlled porosity in various substrates. For example, sodium chloride crystals can be used as a porogen in polymer scaffolds for tissue engineering. The salt is mixed with the polymer solution, then leached out after solidification to create a porous structure.

Acoustic metamaterials are engineered structures designed to manipulate and control sound waves. An example is a periodic array of resonators, such as Helmholtz resonators, embedded in a matrix material. These structures can be designed to create acoustic bandgaps, negative refraction, or sound focusing effects.

Wetting agents are substances that reduce the surface tension of a liquid, allowing it to spread more easily across a surface. An example is polysorbate 20 (Tween 20), commonly used in agricultural sprays to improve the coverage of pesticides on plant leaves.

Lubricants are materials used to reduce friction between moving surfaces. Molybdenum disulfide (MoS₂) nanoparticles are an example of a solid lubricant additive used in oils and greases. These nanoparticles can form a thin, low-friction film on surfaces, enhancing the lubricating properties of the base fluid.

Different salts have varying effects on polymer solubility. Generally, salts with higher valence ions (e.g., Al³⁺, Mg²⁺) are more effective at salting out polymers than monovalent ions (e.g., Na⁺, K⁺). This is due to their stronger interaction with water molecules, which more effectively disrupts the polymer's hydration shell.

Kosmotropic salts can be included in the salt solution. Kosmotropic salts, also known as “water structure makers,” are a class of salts that have a strong ability to interact with water molecules and enhance the structure of water. These salts typically contain ions with high charge density, such as small, highly charged ions. When dissolved in water, kosmotropic salts increase the order and stability of the water structure by strengthening hydrogen bonds between water molecules. This property makes kosmotropic salts particularly effective in the salting out process for polymers, as they compete more strongly with the polymer for water molecules, leading to a more pronounced precipitation or solidification effect. Examples of kosmotropic salts include sulfates, phosphates, and citrates of small, highly charged cations like magnesium or aluminum. In some examples, the salt solution can include an anion comprising CO₃²⁻, SO₄²⁻, S₂O₃²⁻, HPO₄²⁻, H₂PO₄⁻, F⁻, Cl⁻, Br⁻, NO₃⁻, I⁻, ClO₄⁻, SCN⁻, or a mixture thereof. In some examples, the salt solution includes NaCl, CaCl₂, AlCl₃, or a mixture thereof. Chaoptropic salts can be used too.

Temperature can affect the salting out process in two ways: the temperature can influence the solubility of both the polymer and the salt in water and the temperatures can affect the strength of polymer-solvent and polymer-polymer interactions. Generally, increasing temperature enhances polymer solubility, potentially counteracting the salting out effect. However, the specific impact depends on the polymer's temperature-dependent solubility behavior. The additive manufacturing method can be conducted at or proximate to room temperature. For example, the method can be conducted at a temperature in a range of from about 20° C. to about 30° C., about 23° C. to about 27° C., less than, equal to, or greater than about 20° C., 20.5, 21, 21.5, 22, 22.5, 23, 23.5, 24, 24.5, 25, 25.5, 26, 26.5, 27, 27.5, 28, 28.5, 29, 29.5, or about 30° C. The temperatures can refer to the temperature of the salt solution, polymer solution or both. Although temperatures around room temperature are described it is possible for the temperature to as low as about −10° C. and as high as about 40° C.

The pH of the salt solution can significantly affect the salting out process, especially for polymers with ionizable groups. Changes in pH can alter the polymer's charge distribution, affecting its interactions with water and salt ions. For example, at pH values near the polymer's isoelectric point, the salting out effect may be more pronounced due to reduced electrostatic repulsion between polymer chains. A pH of the salt solution can range from 4.0 to 10.0.

As the salt concentration increases, the salting out effect becomes more pronounced. Higher salt concentrations lead to greater competition for water molecules between the salt ions and the polymer, resulting in more effective polymer precipitation or solidification. For example, a concentration of anions in the salt solution is in a range of from about 0.05 M to about 4.00 M, about 0.3 M to about 3.0 M, less than, equal to, or greater than about 0.05 M, 0.50 M, 1.00, 1.50, 2.00, 2.50, 3.00, 3.50, or about 4.00 M.

After solidification the polymer can be modified or functionalized. With specific reference to polyacrylates, they can be functionalized in various ways to enhance their properties and expand their applications. One common functionalization is the incorporation of reactive groups such as carboxyl, hydroxyl, or amine groups along the polymer backbone. This can be achieved through copolymerization with functional monomers or post-polymerization modification. For example, introducing carboxyl groups can improve the polymer's adhesion properties and allow for further chemical modifications. Another approach is grafting, where side chains are attached to the main polymer chain, altering its physical and chemical characteristics. This can include grafting hydrophobic or hydrophilic segments to control the polymer's water affinity. Cross-linking is another important functionalization method, where polymer chains are connected through covalent bonds, enhancing mechanical strength and chemical resistance. This is often achieved using multifunctional monomers or post-polymerization reactions. Surface modification is also common, particularly for polyacrylate particles or films, where techniques like plasma treatment or chemical grafting can alter surface properties without affecting the bulk material. Additionally, the incorporation of stimuli-responsive groups, such as thermosensitive or pH-sensitive moieties, can create smart materials that respond to environmental changes, expanding the polymer's potential applications in areas like drug delivery or smart coatings.

In other examples, the polymer can be coated with silicone. Coating a polymer with silicone is a common technique used to modify surface properties and enhance the functionality of polymeric materials. Silicone coatings can provide various benefits, including improved water repellency, increased chemical resistance, and enhanced thermal stability. The process typically involves applying a thin layer of liquid silicone onto the polymer surface, which then cures to form a durable, flexible coating. This can be achieved through methods such as dip coating, spray coating, or spin coating, depending on the geometry and requirements of the polymer substrate. The silicone coating can be tailored to specific needs by adjusting its composition, thickness, and curing conditions. For instance, adding functional groups to the silicone can improve its adhesion to the polymer surface or introduce specific properties like antimicrobial activity. The resulting silicone-coated polymer often exhibits a combination of the bulk properties of the underlying polymer and the surface properties of the silicone.

Some of the polymers can be dissolved when they are contacted with water. The dissolved polymers can be recycled as feedstock. In some examples, however, it may be desirable to prevent the polymer from being dissolved. For example, if the polymer is used in a device that is exposed to water the silicone coating can be helpful to prevent water from contacting and dissolving the polymer.

In some examples, as a sacrificial component to enhance an additive manufactured structure. For example, it can be used to print a PNIPAM-Alginate structure, and then when the PNIPAM-Alginate structure is immersed in water, only the Alginate remains. This concept is applicable to any ink to cause more porous structure/shrink the polymer. Further, in some examples, causing the shrinkage of printed structure at a specific salt condition, a high-resolution printing can be implemented.

In operation, a container such as a tank holds the salt solution. A dispensing head is positioned to contact the polymer solution with the salt solution. Dispensing heads for liquid dispensing in additive manufacturing processes come in various forms, each suited to different materials and applications. Inkjet printheads, which use piezoelectric or thermal technology, are commonly employed for depositing low-viscosity materials like photopolymers and waxes with high precision. Extrusion nozzles, on the other hand, are ideal for higher viscosity materials such as pastes, gels, and molten thermoplastics, pushing the material through a small opening using pressure. Syringe dispensers offer versatility, working well with a range of viscosities and allowing for easy material changes. In some examples, the syringe dispenser is a handheld syringe. For covering larger areas quickly, spray nozzles atomize liquid materials into fine droplets or mists, though with less precision than other methods. Micro-valve dispensers provide high speed and accuracy for small volume dispensing, utilizing fast-acting valves to control liquid flow precisely. Lastly, pump-based systems, which can include peristaltic, gear, or piston pumps, offer good flow control for metering and dispensing liquids.

In some examples, the dispensing head can be controlled by a computer-aided design (CAD) In a CAD system for additive manufacturing, the control of dispensing head movement is achieved through a sophisticated integration of software and hardware systems. The CAD program generates a detailed 3D model (e.g., predetermined pattern) of the object to be printed, which is then sliced into layers. These layers are translated into a series of coordinates and instructions, known as G-code, which guide the dispensing head's movement. The G-code provides precise directions for the motion control system, dictating the path, speed, and timing of the dispensing head's movement in three-dimensional space. This code is interpreted by the printer's firmware, which then sends electrical signals to the stepper motors or servo motors controlling the dispensing head. The CAD software also allows for the adjustment of various parameters such as layer height, infill density, and print speed, all of which influence the movement patterns of the dispensing head. Advanced CAD programs may incorporate features like toolpath optimization to enhance efficiency and quality, dynamically adjusting the dispensing head's movement based on the geometry of the part being printed. Some systems also utilize closed-loop feedback mechanisms, where sensors monitor the actual position and performance of the dispensing head, allowing the CAD program to make real-time adjustments to ensure accuracy and compensate for any discrepancies between the intended and actual movements.

Advanced CAD systems for additive manufacturing using the salting out method may incorporate simulation capabilities to predict the behavior of the polymer solution upon contact with the salt solution. These simulations can take into account factors such as diffusion rates, local salt concentrations, and polymer chain interactions to optimize the printing process. By predicting the solidification behavior, the CAD system can adjust parameters like dispensing speed, salt concentration gradients, and post-processing steps in real-time, ensuring consistent and high-quality prints across various geometries and material compositions.

The container can include a movable bed that can adjust both vertically and horizontally play a crucial role in containing and manipulating liquid materials. One suitable example is a build platform that can move along the Z-axis (vertically) to control layer thickness and overall build height, while also offering X-Y (horizontal) movement for precise positioning of the liquid material. This type of system is often seen in stereolithography (SLA) 3D printers, where a vat of photopolymer resin is selectively cured layer by layer. Another example is a multi-axis bed system used in direct ink writing (DIW) processes, which can move in three dimensions to allow for complex geometries and overhanging structures. Some advanced systems incorporate tilt functionality, allowing the bed to angle itself to optimize liquid distribution or to facilitate the creation of certain features. Additionally, there are rotating bed systems that combine vertical movement with circular motion, enabling helical or spiral printing patterns for cylindrical objects or specialized applications. These movable beds are typically equipped with high-precision motors and control systems to ensure accurate positioning and smooth movement, which is essential for maintaining the integrity of the liquid material and the quality of the final printed object.

In some examples, a mask can be located between the dispensing head and the container. In additive manufacturing processes, masks can help in preventing unwanted contact between the dispensing solution and the solution in a container. These masks, often referred to as selective masking or shielding systems, are designed to create a barrier between the dispensing head and the target area. The mask typically includes a thin, precisely engineered material that is positioned between the dispensing head and the container holding the solution. It contains carefully designed openings or patterns that allow the dispensed solution to pass through only in specific areas, effectively controlling where the material is deposited. This masking technique is particularly useful in processes like stereolithography. The mask can be static, remaining in a fixed position throughout the build process, or dynamic, changing its pattern or position to create complex geometries. By using a mask, manufacturers can achieve higher precision in material deposition, reduce waste, and prevent cross-contamination between different solutions or materials used in the additive manufacturing process. Additionally, masking can enable the creation of intricate structures or multi-material objects by selectively allowing or blocking the deposition of different solutions in specific areas of the build.

In some implementations of this additive manufacturing method, the mask system can be dynamically controlled to create complex, multi-material structures. By selectively allowing or blocking the deposition of different polymer solutions or varying the exposure to the salt solution, it becomes possible to create objects with spatially controlled properties. This could include gradients in mechanical strength, porosity, or even functionality, such as regions with different drug release profiles in pharmaceutical applications or varying electrical conductivity in electronic components.

The additive manufacturing method described herein can be used to make various devices or assemblies. For example, the additive manufacturing method can be used to build a housing, an apparatus, or a tool. In some examples the polymer can be electrically conductive and the additive manufacturing method can be used to produce an electrical circuit, energy storage device, actuator, soft robot, support structures or combinations thereof.

### EXAMPLES

The following Examples are intended to illustrate an aspect of the disclosure, the disclosure is not limited by this section.

### Example I

### Introduction

Achieving a simple yet sustainable printing technique with minimal instruments and energy remains challenging. Here, a facile and sustainable 3D printing technique is developed by utilizing a reversible salting-out effect. The salting-out effect induced by salt solutions lowers the phase transition temperature of poly(N-isopropylacrylamide) (PNIPAM) solutions to below 10° C. It enables the spontaneous and instant formation of physical crosslinks within PNIPAM chains at room temperature, thus allowing the PNIPAM solution to solidify upon contact with a salt solution. The PNIPAM solutions are extrudable through needles and can immediately solidify by salt ions, preserving printed structures, without rheological modifiers, chemical crosslinkers, and additional post-processing steps/equipment. The reversible physical crosslinking and de-crosslinking of the polymer through the salting out effect demonstrate the recyclability of the polymeric ink. This printing approach extends to various PNIPAM-based composite solutions incorporating functional materials or other polymers, which offers development of water-soluble disposable electronic circuits, carriers for delivering small materials, and smart actuators.

3D printing of polymers enables rapid prototyping and construction of small-scale complex structures at a relatively lower cost compared to traditional subtractive manufacturing (i.e., removal of materials) or formative manufacturing (i.e., reshaping/molding of materials) methods (1-4). Among the various additive manufacturing techniques, such as fused deposition modeling (FDM), stereolithography (SLA), selective laser sintering (SLS), and direct ink writing (DIW), the DIW method has gained extensive attention owing to its cost-effectiveness with simple procedures and fewer energies and a relatively wider range of material selections. The DIW works by extruding inks with mechanical or pneumatical force out of a syringe needle/nozzle onto a solid substrate. These inks should have viscoelastic and shear-thinning properties for smooth extrusion and have sufficiently high viscosity in the range of a few mPa s to kPa s for shape retention after the extrusion. To achieve such good printability and structural integrity of the extruding inks, rheological modification and post-processing steps (e.g., chemical crosslinking under heat or light), respectively, are generally employed. However, the rheological modification often provokes a component precipitation or flocculation due to their sensitivity to the ionic strength of ink precursors as well as an increment in the complexity of the 3D printing process. Post-processing usually requires additional equipment, energy, and catalysts along with chemical crosslinkers (e.g., crosslinkers with aldehyde, cyanoacrylate, or epoxide groups), which may adversely affect human health and environments. Furthermore, the resultant crosslinked structures suffer from recycling due to the limitation in dissolving or decomposing the structures through aqueous-based systems sustainably. Therefore, while achieving good printability and structural integrity of the printed shape, different approaches enabling 3D printing need to be developed in a simple and sustainable system/process.

The solubility of polymers, including proteins and colloids with hydrophilic and hydrophobic domains, is influenced by salt ions, a phenomenon known as the Hofmeister effect. Certain salt ions can be strongly hydrated, stealing water molecules from the polymers and thus leading to a salting-out effect. As a result, the addition of such salts to a polymeric solution causes precipitation, aggregation, or gelation of the polymeric molecules/chains through an increase in hydrogen bonds or hydrophobic interactions among the molecules/chains. Recent studies have highlighted mechanically enhanced polymeric materials comprising gelatin, cellulose nanofibrils, or poly(vinyl alcohol) by employing the salting-out effect to induce the formation of intermolecular physical crosslinks, such as hydrogen bonds and hydrophobic interactions.

In this study, the salting-out effect was implemented in a sustainable 3D printing technique without requiring rheological modifiers, chemical crosslinkers, and additional post-processing steps/equipment. The salting-out effect induced by salt solutions demonstrates the spontaneous formation of physical crosslinks (i.e., hydrophobic interactions) between poly(N-isopropylacrylamide) (PNIPAM) chains and consequential solidification of PNIPAM solutions. The PNIPAM solutions are extrudable through syringe needles without high-extruding force due to their low viscosity in the magnitude of 10-100 Pa·s and shear-thinning behavior. In particular, the PNIPAM solution that inherently underwent a phase transition from the coil-to-globule state at lower critical solution temperature (LCST) was substantially influenced by salt ions. For instance, a CaCl₂ solution of concentrations exceeding 2M lowered the LCST below 10° C., in which the salt ions facilitate the dehydration and phase transition of PNIPAM. This salting-out effect consequently enabled the extruded PNIPAM solution inks to immediately undergo the phase transition and solidification with physical crosslinking formation within PNIPAM chains, upon contact with a salt solution at room temperature (˜22° C.). The formation of physical crosslinks and the solidification, resulting from the salting-out effect, was consistently observed even when the PNIPAM solution contained functional materials (e.g., hydrophilic food dye, hydrophilic MXene, and hydrophobic carbon nanotube (CNT)) or other polymers (e.g., polyvinyl alcohol (PVA), polyacrylamide (PAM), and alginate (Alg)). This printing technique, therefore, eliminates the need for rheological modifiers and chemical crosslinkers in the printing ink and the need for post-curing steps, specialized equipment, and high energy and cost. Moreover, the printed structures were easily dissolved in water and recyclable, representing this printing technique as a simple and sustainable system. This printing approach using the PNIPAM-based system further demonstrated the strong potential for fabricating several structures/devices, such as a water-soluble disposable electronic circuit, a carrier for delivering functional materials, and an actuator with multimodal shape morphing that responds to salt conditions.

### Methods

### Materials

N-isopropylacrylamide (NIPAM, >98.0%, stabilized with 4-methoxyphenol) and sodium chloride (NaCl, assay>100%) were purchased from Tokyo Chemical Industry (TCI) and MP Biomedicals, respectively. N,N,N′,N′-tetramethylethylenediamine (TMEDA), ammonium persulfate (APS), calcium chloride dihydrate (CaCl₂·2H₂O, assay≥99%), lithium chloride (LiCl, assay≥99%), zinc bromide (ZnBr₂, assay=99%), sodium chloride (NaCl, assay≥99%), aluminum chloride hexahydrate (AlCl3·6H2O, assay≈99%), CNT (multi-walled, >90% carbon basis), PVA (Mw 89,000-98,000, 99+% hydrolyzed), acrylamide (AM, assay≥99%), and alginic acid sodium salt from brown algae (Alg, medium viscosity), Pluronic F-127, lithium fluoride (LiF, assay=99.995%), and hydrocholoric acid aqueous solution (HCl, 35%) were purchased from Sigma-Aldrich. Laponite-RD (Nanoclay) was purchased from BYK Additives & instruments. Layered ternary carbide (Ti3AlC2) MAX-phase powder (particle size<200 μm) was obtained from Carbon-Ukraine Ltd. Water is Milli-Q water.

### Preparation of MXene Nanosheets

MXene (Ti₃C₂Tₓ nanosheets were synthesized based on a previous study. In detail, LiF (2 g) was mixed in 40 mL of a 9M HC solution in a perfluoroalkoxy alkane flask for 30 min at 35° C. A 2 g of Ti₃AlC₂ MAXphase powder was carefully added to the LiF-HCl mixture and then mixed for 24 h at 35° C. to obtain a MXene-dispersed solution. This acidic solution was neutralized through centrifugation at 1507×g for 5 min until the pH of the supernatant reached ˜6. Afterward, a bath sonication was conducted to the neutralized MXene dispersion to delaminate the MXene. By-products and non-delaminated MXenewere removed through centrifugation at 651×g for 5 min, and then the supernatant was freeze-dried overnight to obtain a powder of delaminated multi-layered MXene nanosheets.

### Preparation of PNIPAM-Based Solutions and Their Printing

PNIPAM solutions were prepared by mixing NIPAM monomer, APS (3 mol/mol % of NIPAM) as an initiator, and TMEDA (2 mol/mol % of NIPAM) as an accelerator for free radical polymerization. The PNIPAM concentration was controlled from 0.5 to 1.6 M. For 1.0M PNIPAM-based composite solutions, a MXene, CNT, PVA, PAM, or Alg dispersion/solution was mixed with the NIPAM, APS, TMEDA mixture to synthesize a PNIPAM/Dye, PNIPAM/MXene, PNIPAM/CNT, PNIPAM/PVA, PNIPAM/PAM, or PNIPAM/Alg composite solution. For the PNIPAM/MXene and PNIPAM/CNT solutions, the final concentration of MXene and CNT was set as the particle/polymer wt/wt ratio was 10%, respectively. For the PNIPAM/MXene+CNT solution, the final concentration of the sum of MXene and CNT (1:1 weight ratio) was 20%. For the PNIPAM/PVA and PNIPAM/Alg solutions, the final concentration of PVA and Alg was prepared as 2.3% (wt/wt). For the PNIPAM/PAM solution, a PAM solution that was first synthesized by polymerizing AM monomer, APS (5 mol/mol % of AM), and TMEDA (4 mol/mol % of AM) was mixed with the NIPAM, APS, TMEDA mixture to obtain the PNIPAM/PAM solution comprising 1M PAM. In the case of the PNIPAM/Dye solution, a few microliters of food dye were added to the as prepared PNIPAM solution. The solutions were used after at least a day to ensure the polymerization with complete monomer conversion based on the previous studies. The molecular weight (Mw) of PNIPAM and PAM were ˜6.58×106 and 5.97×105 g mol⁻¹, respectively, according to gel permeation chromatography (size-exclusion chromatography) analysis. The 1.0MPNIPAM-based solutions were printed into pre-designed structures using a 3D printer (ROKIT INVIVO) and a blunt needle of 20-25 gauge at room temperature (˜22° C.). For spontaneous and rapid solidification of the extruded solution, 3M CaCl₂ solution was mainly used unless the other was notified in the main text.

### Preparation of a Support Bath

Pluronic F-127 solution (35 wt/wt %) was prepared by dissolving Pluronic F-127 powder in water at an ice bath. A 6M CaCl₂ solution was then blended with the prepared Pluronic F-127 solution in a 1:1 volume ratio to obtain the mixture with ˜3M CaCl₂, and the mixture was stored in a freezer for a full dissolution in a liquid state. This mixture was then gelated at room temperature to obtain a physical gel for a support bath. Preparation of PNIPAM/nanoclay bottom matrix for folding

### Actuators

The precursor solution for PNIPAM/nanoclay bottom matrix was prepared following a previously reported method. In detail, 10 mL of 2M NIPAM monomer solution, 120 μL of 0.13M MBAA solution as a chemical crosslinker, 0.04 g of Irgacure 2959 as an initiator, and 1 g of nanoclay as a rheological modifier were thoroughly mixed until no visible nanoclay aggregate was observed. The resultant mixture was loaded into a plastic syringe, and bubbles in the syringe were removed using the centrifuge. The mixture was printed into a pre-designed structure using a 3D printer (CELLINK BIO X) onto a flat glass substrate and then cured under 365 nm ultraviolet at 253 mW cm⁻² for 144 s (Omnicure).

### Rheological Measurements

Storage modulus-temperature curves were obtained using a rheometer with a 40 mm cone plate and a 500 μm truncation gap (TA Instrument, Discovery HR-3). This rheological measurement was conducted at a frequency of 1.0 Hz, a strain of 1.0%, and a heating/cooling rate of 2° C./min. Pure 1M PNIPAM solution without salts was placed on the rheometer stage of ˜10° C. to investigate the typical LCST of PNIPAM solution. For the LCST reduced by the salting-out effect, the 1M PNIPAM solidified within a salt solution of 1-4M NaCl, CaCl₂, or AlCl₃ was placed on an ˜20° C. rheometer stage, equilibrated until it transited to the coil state, and then warmed up. The LCST was determined as the onset (starting point) of an increase in the storage modulus. For the measurement of changes in storage and loss moduli over time following the addition of CaCl₂ solution, the PNIPAM solution was subjected to an angular frequency of 10 rad s⁻¹, a strain of 1.0%, and a 1000 μm gap. The CaCl₂ solution diffused into the PNIPAM solution, through the edge of the PNIPAM solution placed in between the rheometer top geometry and bottom stage. In the case of the viscosity measurement over the shear rate (i.e., flow sweep) and moduli measurement over the frequency change (i.e., frequency sweep), samples were tested on a 20° C. stage with the 40 mm cone plate at a 52 μm truncation gap. During the frequency sweep, 1.0% oscillation strain was applied.

### Adhesion Force Measurement

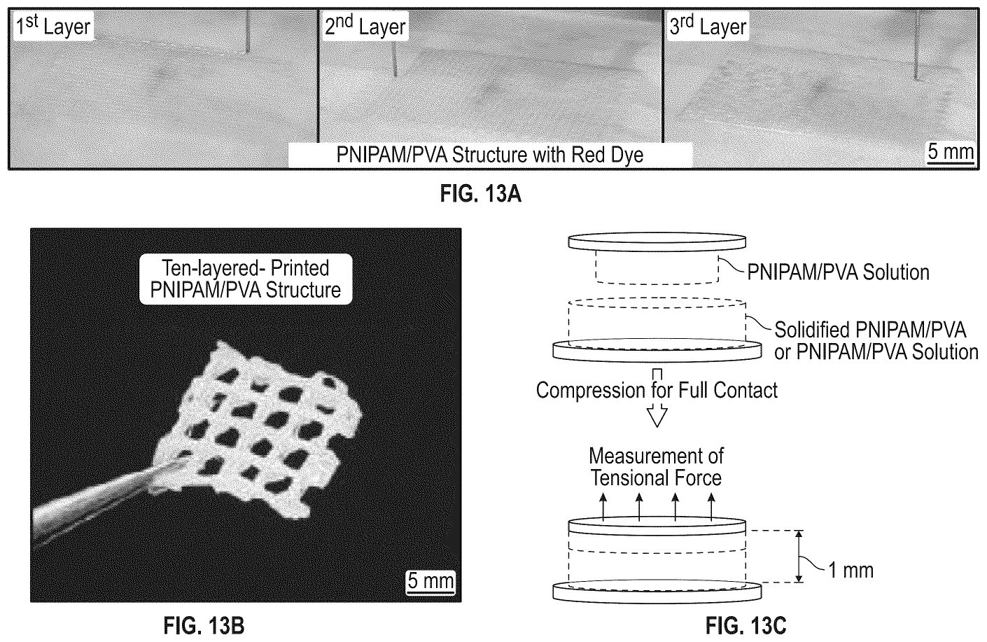

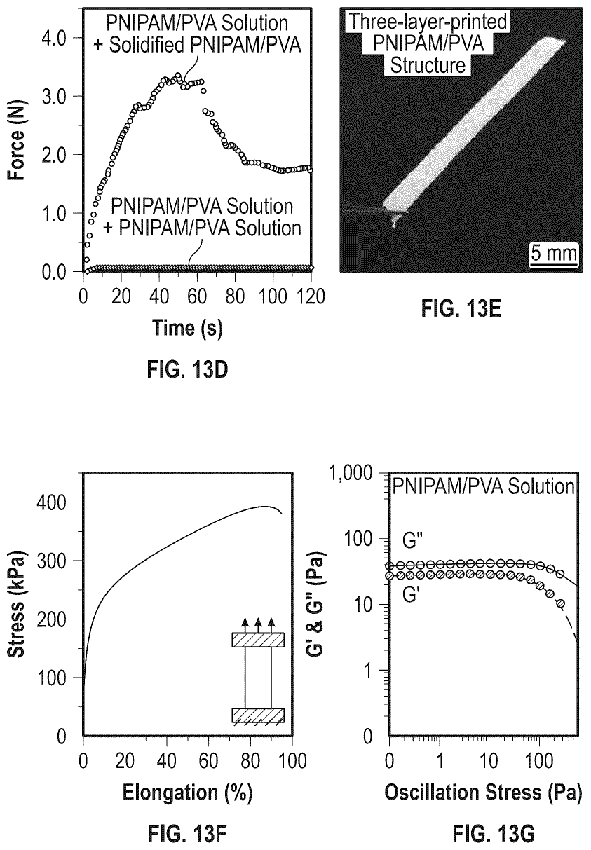

To measure the adhesion force between the PNIPAM/PVA solution and the PNIPAM/PVA solution (FIG. 13c, d), 2 mL of PNIPAM/PVA solution was applied on the rheometer bottom stage and 1 mL of PNIPAM/PVA solution on the rheometer top geometry, respectively. Afterward, two solutions were contacted for 20 s at the set gap of 1000 μm, and the tensile force was recorded, resulting from the top geometry moving upward. In the case of adhesion force between the solidified PNIPAM/PVA (as the first layer) and the PNIPAM solution (as the second layer extruded top on the first layer), 2 mL of PNIPAM/PVA solution was applied on the rheometer bottom stage and 3M CaCl₂ solution was added to the PNIPAM/PVA solution. The PNIPAM/PVA solution was slightly solidified by salt ions for 20 s, and the top geometry with 1 mL of PNIPAM/PVA solution was promptly contacted with the slightly solidified PNIPAM/PVA placed on the bottom stage for 20 s at the set gap of 1000 μm. The tensile force resulting from the top geometry moving upward was recorded.

### Characterization

X-ray diffraction (XRD) analysis was performed under ambient conditions in open air, using Anton Paar XRDynamic 500. SEM images were obtained from an FEIQuanta FEG250 SEM. Lyophilized samples frozen in liquid nitrogen and dried at −80° C. for 3 d (Labconco FreeZone) were prepared and coated with iridium for 8 s for SEM imaging. FTIR spectra data were obtained using the attenuated total reflectance (ATR) mode of a Thermo Scientific™ Nicolet™ iS50 FTIR spectrometer with a diamond ATR attachment. Conductivity was measured using a 2-probe Ohmmeter mode of Keithley 2450 multimeter. Tensile mechanical tests were performed using the Instron 5982 universal testing machine with a 100N load cell. Filament-shaped specimens of ˜1 mm diameter and rectangle-shaped specimens of ˜8 mm width and ˜1.5 mm thickness were prepared and tested at 5 mm min⁻¹ load speed. Digital optical microscope (Keyence VHX) was used to capture images of the folding actuator. Gel permeation chromatography analysis was performed using 4.0 mg/mL PNIPAM and 7.1 mg/mL PAM aqueous solutions through Shimadsu™ LC-2050 having UV detector, with Wyatt Instruments™ MALS light scattering (LS) and OptiLab differential refractive index (RI) detectors. The molecular weight of polymers was almost similar regardless of the detectors, and the molecular weight stated above was calculated based on the UV detector.

### Results

### Salting-Out Effects on Phase Transition of PNIPAM Solution

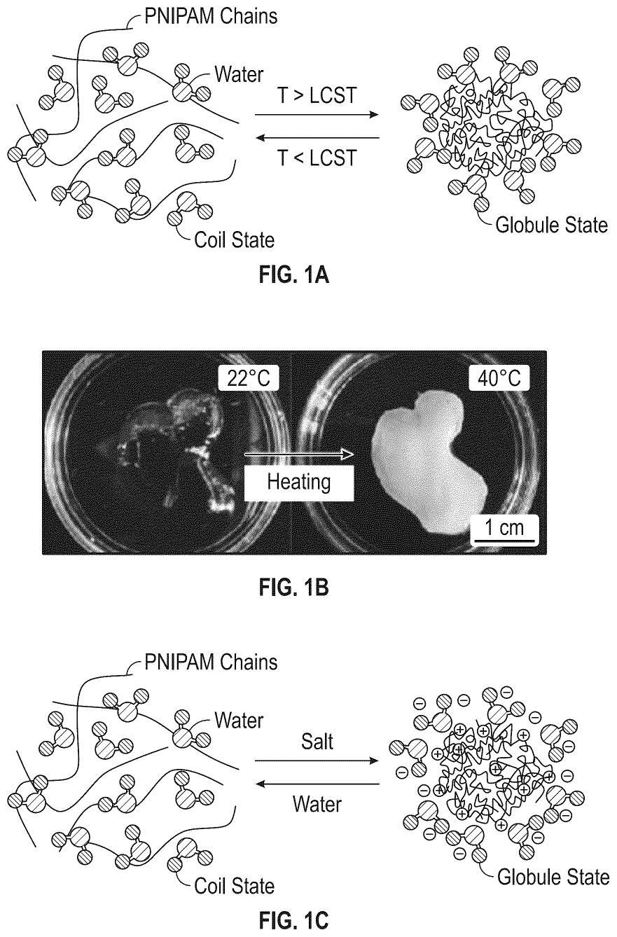

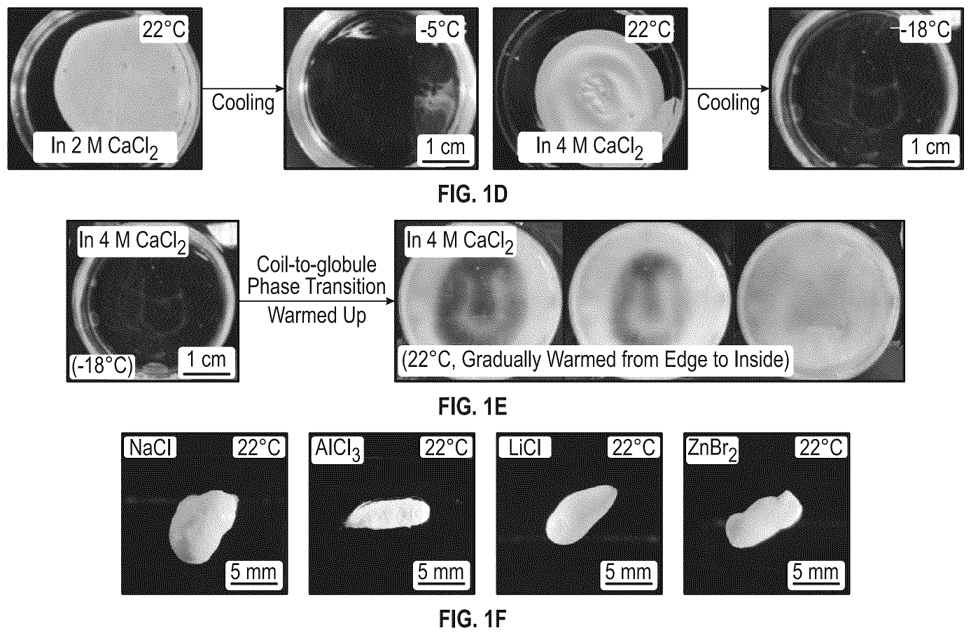

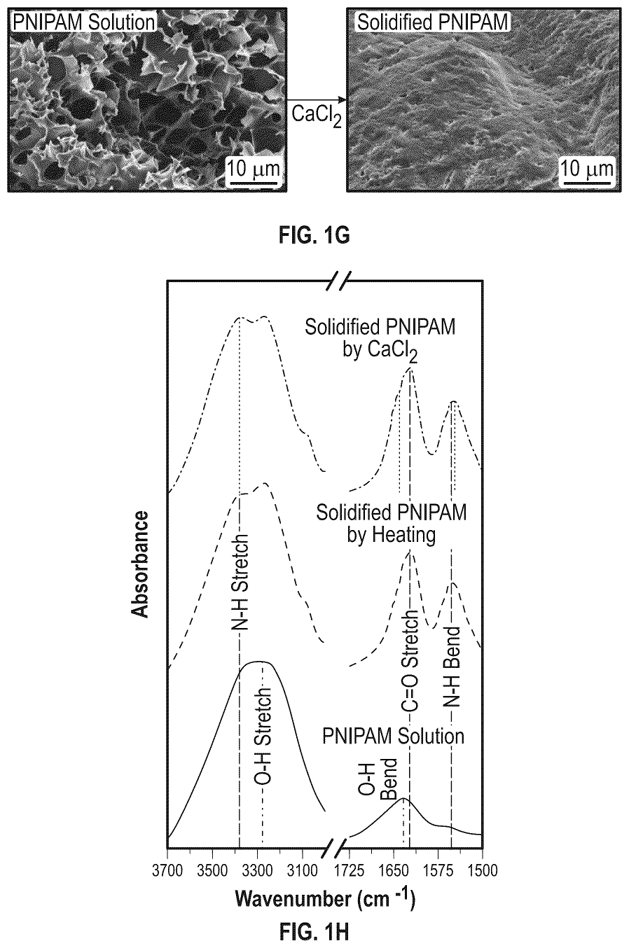

The PNIPAM chains were in a state of solvated by water molecules below the phase transition temperature (i.e., LCST); in contrast, at elevated temperatures above LCST, the PNIPAM chains lost dipole-dipole and hydrogen-bonding interactions with water molecules and then released bound water, thereby aggregating with the formation of hydrophobic interactions (FIG. 1A). These processes induced a phase transition of PNIPAM from the coil-to-globule state and the solidification of PNIPAM solutions. In practice, 1M PNIPAM solution solidified and turned into opaque white through the phase transition when heated above LCST, typically 30-33° C. (FIG. 1B).

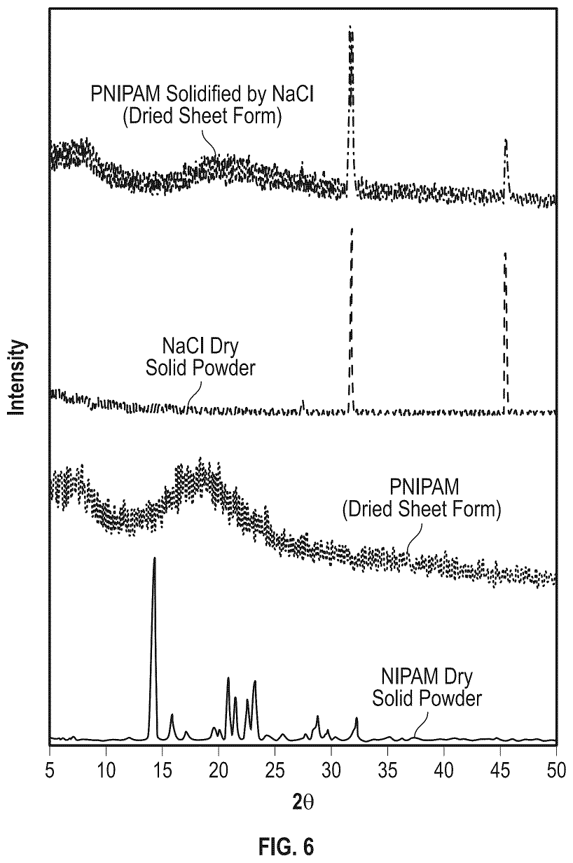

This phase transition and solidification can be induced by salt ions causing the salting-out effect, even at room temperatures rather than elevated temperatures (FIG. 1C). For example, the 1M PNIPAM solution in the coil state spontaneously solidified in the globule state at room temperature (22° C.) upon the addition of a CaCl₂ solution with a concentration of 2M or higher (FIG. 1D). The solidified opaque white sample comprising aggregated and physically crosslinked PNIPAM chains returned to the coil state upon cooling to subzero temperatures, thereby becoming a transparent solution reversibly. Specifically, the solidified PNIPAM within 2M CaCl₂ solution was observed to return to a transparent solution at subzero (FIG. 1D, left); and the solidified PNIPAM within 4M CaCl₂ solution returned to a transparent solution at a substantially lower temperature ˜−18° C. (FIG. 1D, right). This phenomenon implies that the LCST of PNIPAM was declined by the salt ions causing the salting-out effect, and the decrement of LCST varies depending on the salt ion concentration. According to previous theoretical studies, the decrease in LCST of PNIPAM can be explained as follows (FIG. 1C). Salt anions polarize water molecules bound to PNIPAM chains, disrupting hydrogen bonds between the PNIPAM chains and water molecules. This disruption facilitates dehydration and aggregation of PNIPAM chains, thereby forming physical crosslinks (hydrophobic interactions) between the aggregated PNIPAM chains. Salt cations simultaneously fill the spaces near the dehydrated PNIPAM chains and bind to the amide oxygen atoms of PNIPAM. Namely, the salt ions induce the coil-to-globule phase transition analogous to the temperature elevation, and the ions of sufficient amounts decrease the LCST significantly and result in the solidification of PNIPAM solutions at room temperature. This phase transition by the salting-out effect was reversible. The liquified PNIPAM within the 4M CaCl₂ (FIG. 1D, right) solidified again over the temperature elevation (FIG. 1E). The liquified PNIPAM placed on the table at room temperature was gradually solidified from edge to inside. This observation indicated that the phase transition, coil-to-globule and globule-to-coil, was a reversible reaction resulting from the reversible physical crosslinking and de-crosslinking of PNIPAM, respectively. As well as the CaCl₂ solution, other various salt solutions, such as 2M NaCl, AlCl₃, LiCl, and ZnBr₂ solutions, demonstrated the solidification of the PNIPAM solution (FIG. 1F). Such solidification by salt ions did not induce PNIPAM crystallization (FIG. 6). This solidification caused changes in the internal structures and intermolecular interactions among PNIPAM chains. Cross-sectional scanning electron microscopy (SEM) images of lyophilized samples of the PNIPAM solution exhibited highly porous structures due to the high water content, whereas the lyophilized sample of the PNIPAM solidified within the CaCl₂ solution showed a non-porous dense structure (FIG. 1G). Fourier-transform infrared (FTIR) analysis further confirmed that the salt ions significantly increased interactions between PNIPAM chains in the globule state (FIG. 1H). The PNIPAM solution exhibited strong peaks corresponding to O—H stretching and bending vibrations at 3277 and 1632cm⁻¹, respectively, due to numerous hydrogen bonds of water molecules. Heating (above 40° C.) resulted in the PNIPAM dehydration and thus the appearance of peaks, which were initially hidden by hydrated water molecules, corresponding to N—H stretching, C═O stretching, and N—H bending vibrations at approximately 3374, 1623, and 1553 cm⁻¹, respectively. The salt ions contributed to more effective dehydration than temperature elevation and to more formation of hydrophobic interactions among the PNIPAM chains, identified as peak changes in each vibration. The solidified PNIPAM by the CaCl₂ exhibited amplified N—H stretching peak at 3374 cm⁻¹, broadened C═O stretching peak toward higher wavenumber (from 1632 to 1645 cm⁻¹), and shifted N—H bending peak toward lower wavenumber (from 1553 to 1549 cm⁻¹) than those of solidified PNIPAM by heating. Therefore, the salting-out effect definitely triggered the phase transition of PNIPAM solutions, resulting in the spontaneous solidification of the PNIPAM solution with increases in intermolecular hydrophobic interactions in the globule state.

### Shifts in Phase Transition Temperature by Salt Ions

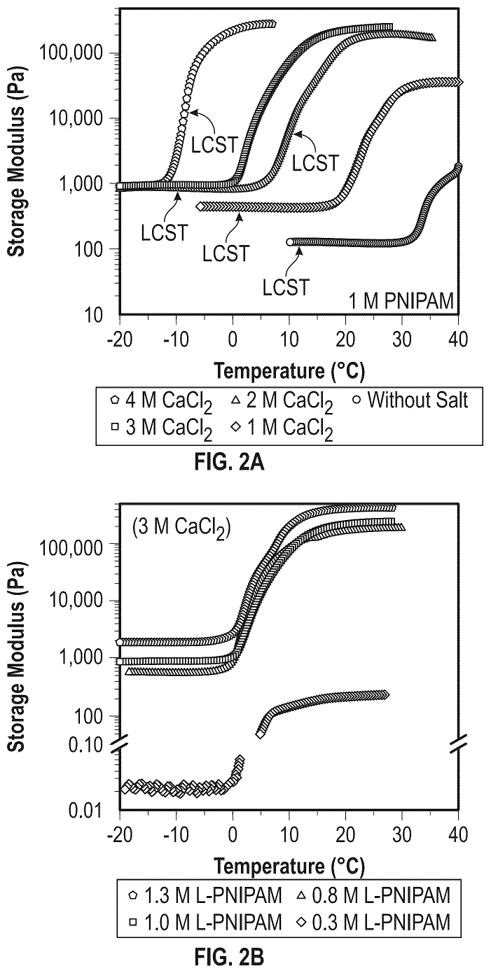

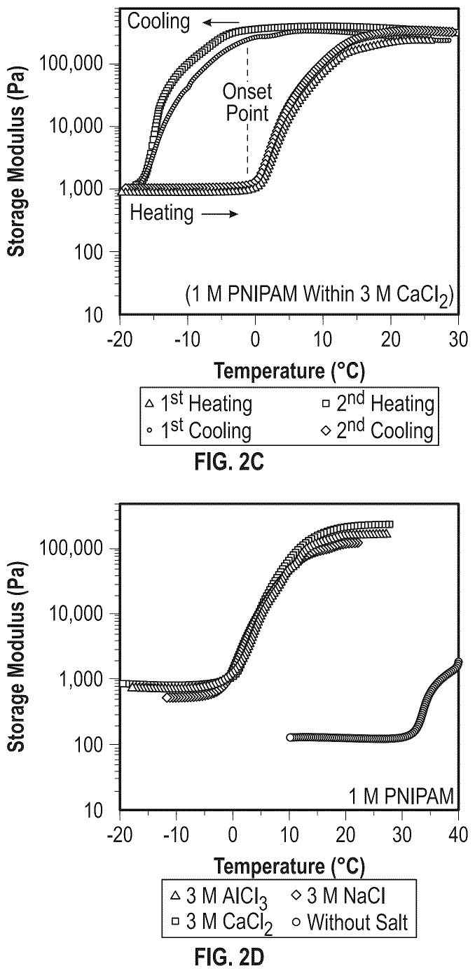

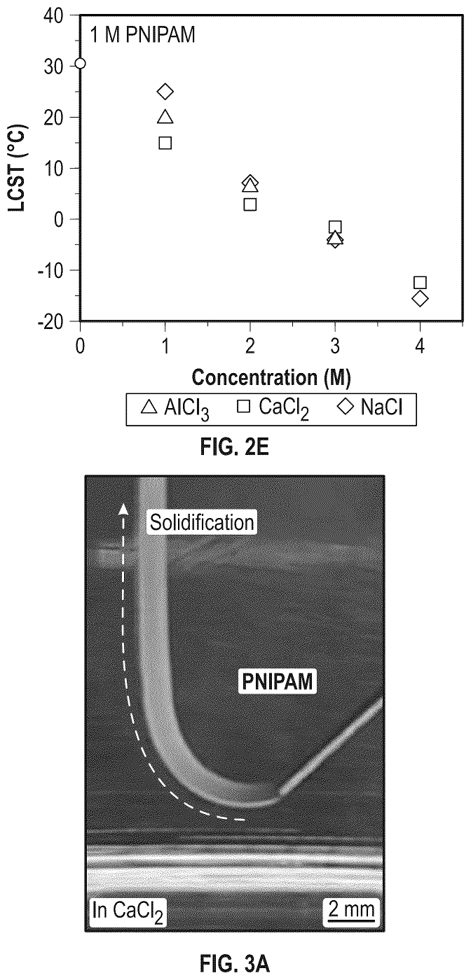

To clarify the effects of the presence of salts and PNIPAM concentrations on the phase transition temperature (i.e., LCST of PNIPAM solution), the storage modulus change of PNIPAM over temperature elevation was examined (FIG. 2) because gelated or solidified materials can store substantial energy and exhibit high storage modulus, unlike liquid materials. To conduct this measurement, 1M PNIPAM that solidified within a NaCl/CaCl₂/AlCl₃ solution with different concentrations (1-4M) was placed on an ˜−20° C. rheometer stage and equilibrated until it transited to the coil state; it was then warmed at a 2° C. min⁻¹ heating rate. For the salt-free condition, the PNIPAM solution was placed on the cold stage of 10° C. and warmed up at the same heating rate.

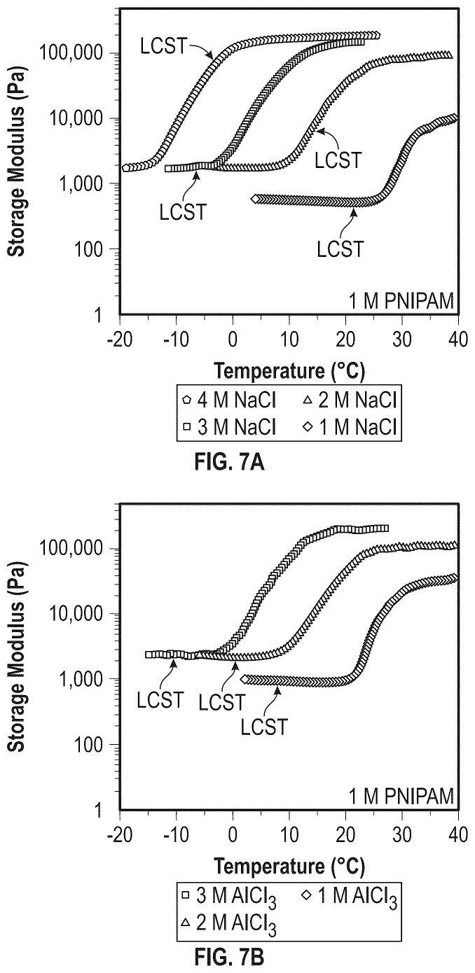

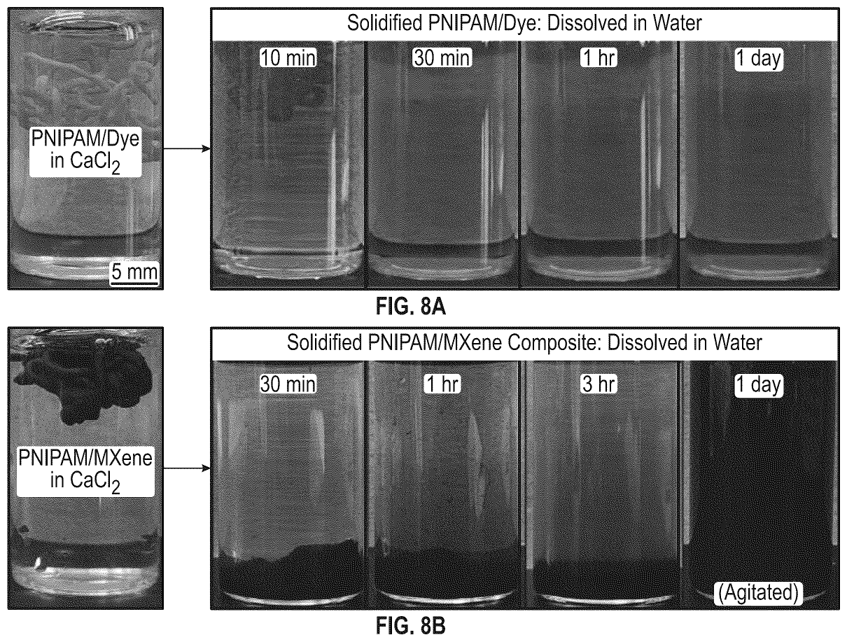

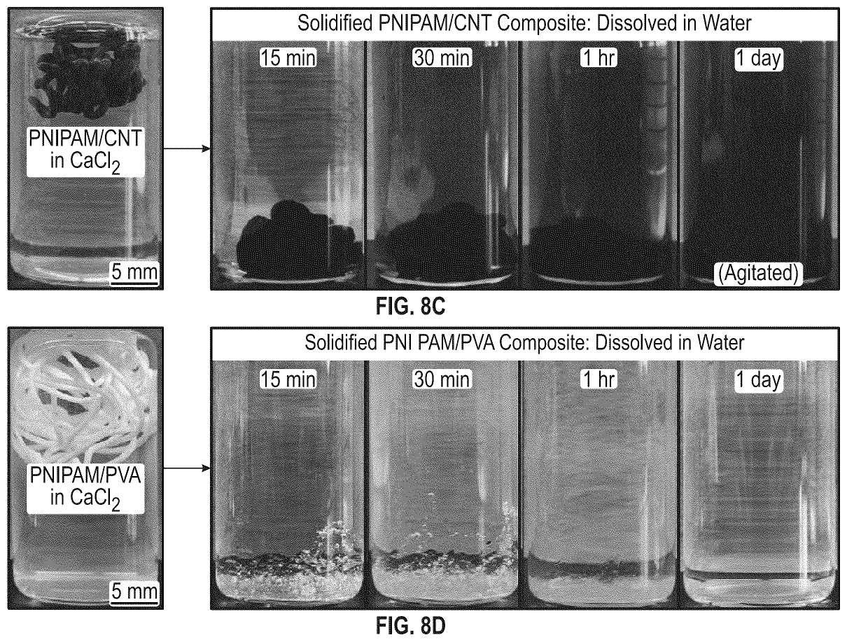

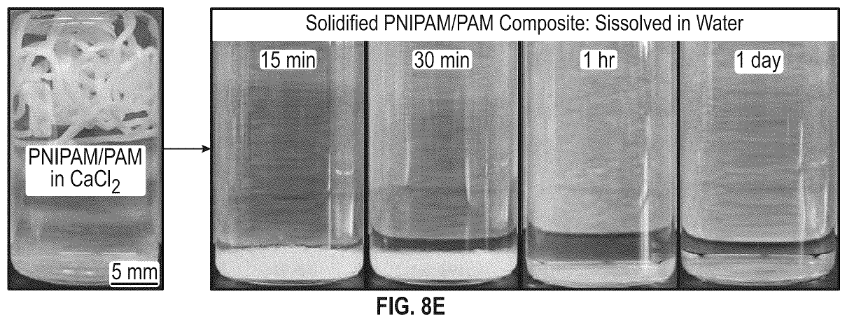

While the PNIPAM solution without salts exhibited the phase transition near 30-31° C., which corresponds to the onset of the storage modulus increase, the LCST of PNIPAM solution within a salt solution significantly decreased in proportion to the concentration of CaCl₂ in the range of 1-4M (FIG. 2A). The slope of the phase separation region, especially near the onset, became steeper with a higher concentration of CaCl₂. The greater gradient in salt concentration led to the faster penetration of ions into the sample, thus accelerating the PNIPAM dehydration. Such phase transition phenomenon was consistently observed in PNIPAM with different concentrations (FIG. 2B). The PNIPAM in the concentration range from 0.3-1.3M, which solidified within 3M CaCl₂ solution, exhibited a similar phase transition temperature. In addition, the phase transition was reversible upon heating and cooling cycles (FIG. 2C). During these cycles, the onset temperature of the increase in storage modulus over temperature elevation and the onset temperature of the decrease in storage modulus over temperature reduction were identical. Further, the trivalent AlCl₃ and monovalent NaCl salt ions resulted in a similar phase transition trend to divalent CaCl₂ salt ions (FIG. 7). Representatively, the PNIPAM that solidified within a 3M NaCl, CaCl₂, or AlCl₃ solution drew almost the same storage modulus-temperature graph (FIG. 2D). The proportional decrease in LCST along the increase in NaCl, CaCl₂, or AlCl₃ concentration reveals that the phase transition was significantly influenced by the salt concentration, rather than the mono-, di-, or trivalent cation types (FIG. 2E).

### Spontaneous and Instant Solidification of PNIPAM-Based Solutions by Reversible Physical Crosslinking

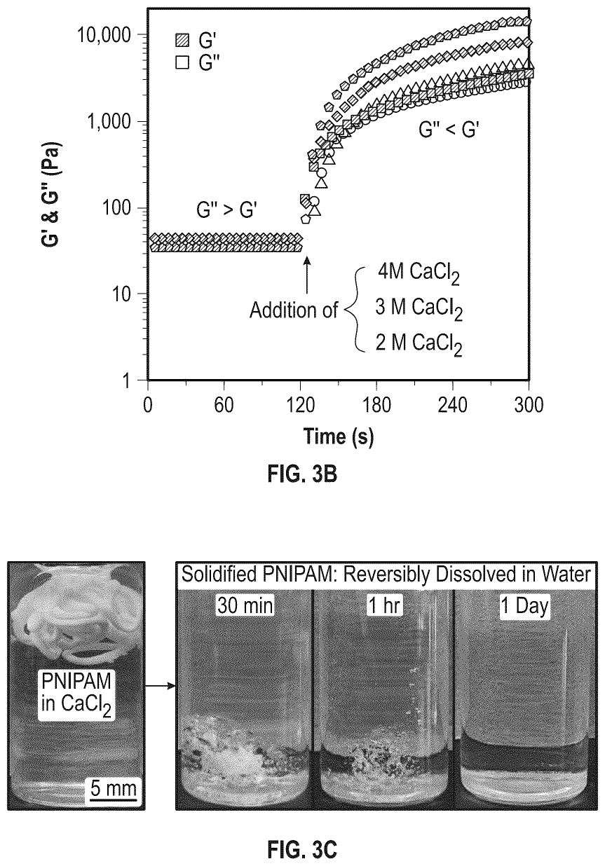

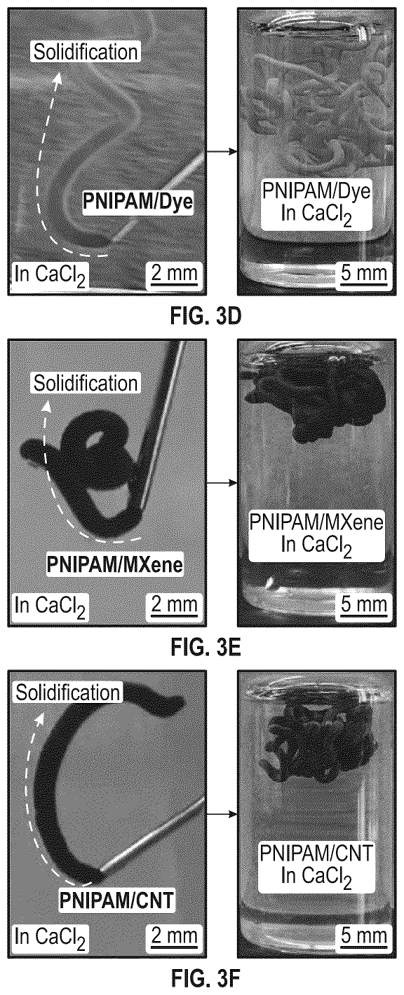

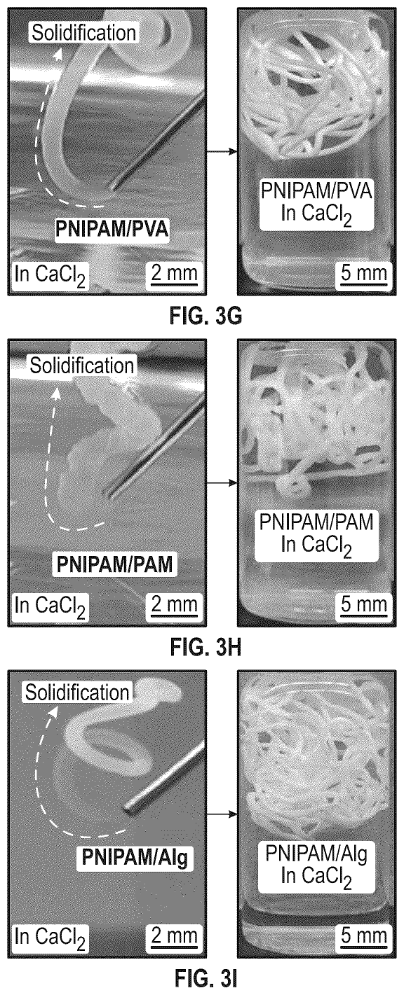

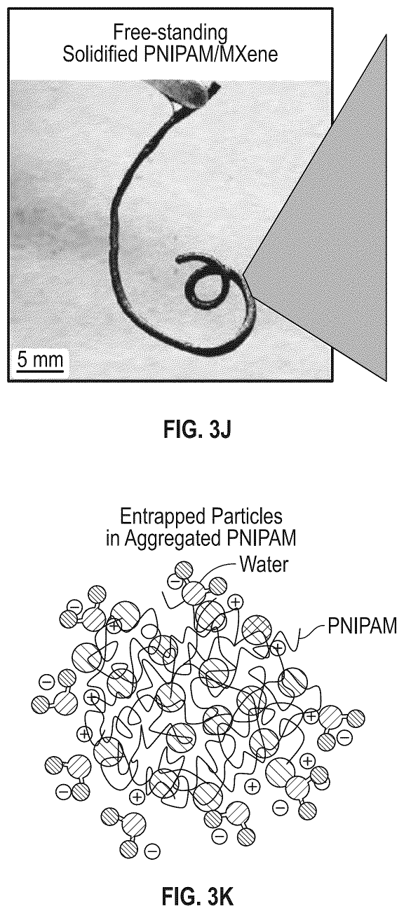

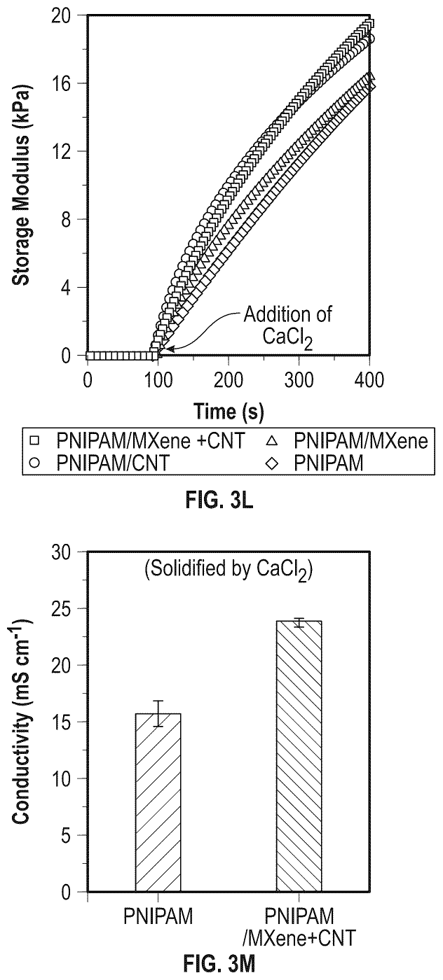

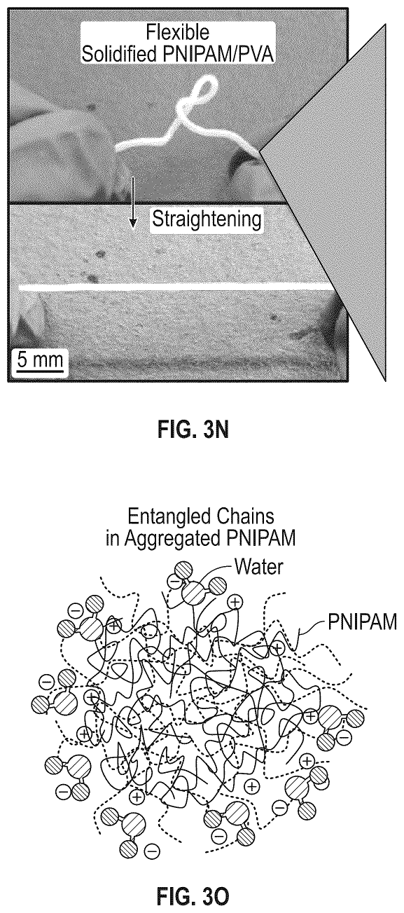

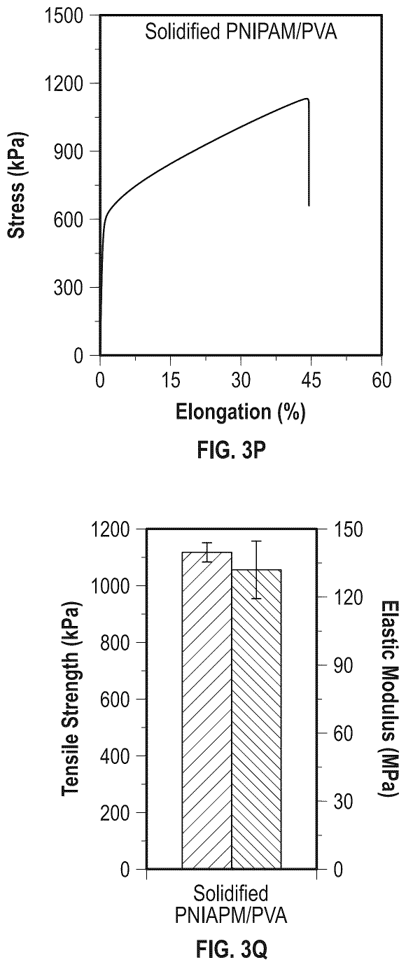

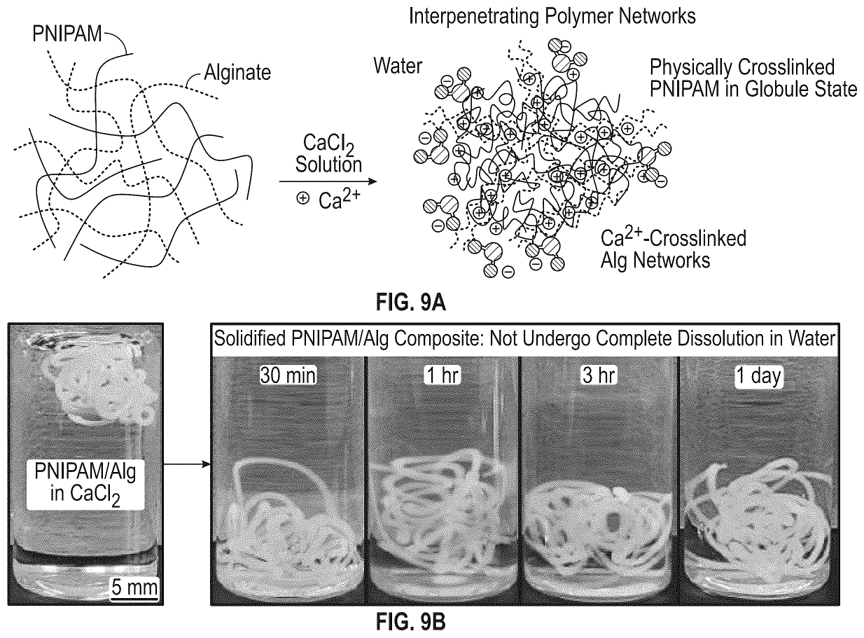

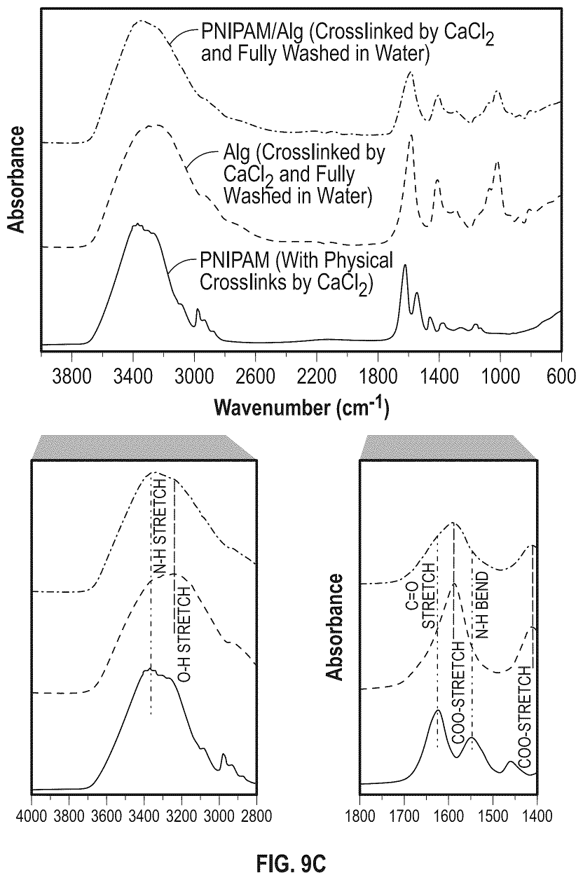

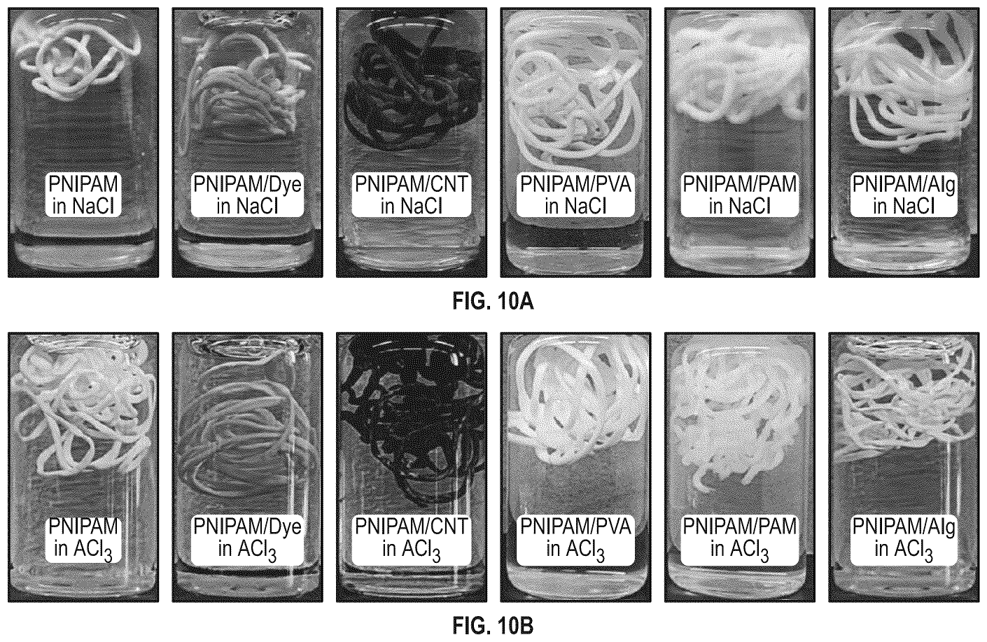

Based on the understanding of the salting-out effect on the PNIPAM solution and consequential solidification, the PNIPAM-based solutions were examined for being readily extruded through a syringe needle and spontaneously and immediately solidified upon contact with a salt solution. The physically crosslinked PNIPAM was investigated for reversible de-crosslinking when exposed to water; water can remove salt ions between PNIPAM chains, resulting in the globule-to-coil transition (i.e., an increase in LCST beyond room temperature). For this purpose, not only was a single component pure PNIPAM solution prepared, but also various kinds of PNIPAM based composite solutions comprising functional materials (either hydrophilic or hydrophobic additives) or other polymer materials: PNIPAM/Dye, PNIPAM/MXene, PNIPAM/CNT, PNIPAM/MXene+CNT, PNIPAM/PVA, PNIPAM/PAM, and PNIPAM/Alg. The PNIPAM solution was extruded through a syringe needle (e.g., 20 gauge needle) and spontaneously solidified in 3M CaCl₂ solution, and the extruded PNIPAM preserved its shape as extruded (FIG. 3A). The color gradient turning into opaque white indicates that the extruded PNIPAM was in the process of solidification upon contact with salt ions. To validate this spontaneous and instant solidification, the storage (G′) and loss (G″) moduli changes of the 1M PNIPAM solution upon contact with different concentrations of CaCl₂ solution was examined (FIG. 3B). Before the solidification, the PNIPAM solution exhibited G″ slightly larger than G′. Upon the addition of CaCl₂ solution to the PNIPAM solution at 120 s, G′ significantly increased, surpassing G″, resulting from the phase transition and solidification of PNIPAM. The rate of changes in G′ was faster with a higher concentration of CaCl₂ solution. Note that the actual time required to complete the solidification of the extruded solution was considerably shorter than the time duration of moduli increase shown in the rheometer test (from the addition of CaCl₂ solution at 120 s to 300 s in FIG. 3B). This time delay was caused by the slower diffusion of CaCl₂ through a narrow gap (1000 μm truncation gap) between the rheometer stage and plate. The exposed area to salt ions per volume of PNIPAM solution in this measurement was constrained to be smaller than in the case of direct solution extrusion in a salt solution. The solidified sample fully dissolved in water (i.e., without salt) at room temperature (˜22° C.) within a few hours, resulting from the LCST shift beyond the room temperature, which indicates the de-crosslinking of PNIPAM chains along the globule-to-coil phase transition (FIG. 3C). Similarly, PNIPAM-based composite solutions, including PNIPAM/Dye (FIG. 3D), PNIPAM/MXene (FIG. 3E), PNIPAM/CNT (FIG. 3F), PNIPAM/PVA (FIG. 3G), PNIPAM/PAM (FIG. 3H), and PNIPAM/Alg (FIG. 3I) were readily extruded from the needle and solidified in 3M CaCl₂. These extruded and solidified PNIPAM composite samples were completely dissolved in water within a few hours, except for PNIPAM/Alg (FIG. 9). In the case of the PNIPAM/Alg solution, the solidified PNIPAM/Alg comprises interpenetrating polymer networks because Alg chains participate in crosslinking by Ca2+ ions (FIG. 9A). This solidified PNIPAM/Alg did not completely dissolve in water (FIG. 9B), and FTIR analysis underpinned this observation (FIG. 9C). The strong peaks corresponding to the PNIPAM chain (N—H stretch, C—O stretch, and N—H bend) and the Alg chain (O—H stretch and COO— stretch) were all identified in the solidified PNIPAM/Alg that was thoroughly rinsed in water for a few days. The instant solidification of various PNIPAM based composite solutions was further implemented by different salt solutions, 3M NaCl and AlCl₃ solutions, respectively (FIG. 10). These results verify that adding additives, fillers, or polymers to the PNIPAM solution generally does not hinder the phase transition of PNIPAM, physical crosslinking (solidification) in salt solutions, and decrosslinking (dissolution) in water. Exceptionally, as for a polymer (e.g., Alg) forming another type of crosslinking in addition to the physical crosslinking of PNIPAM, the interpenetrating networks can be formed and be less or not dissolved; this partial or nearly non-dissoluble PNIPAM-based system in water could be adopted for specific applications.

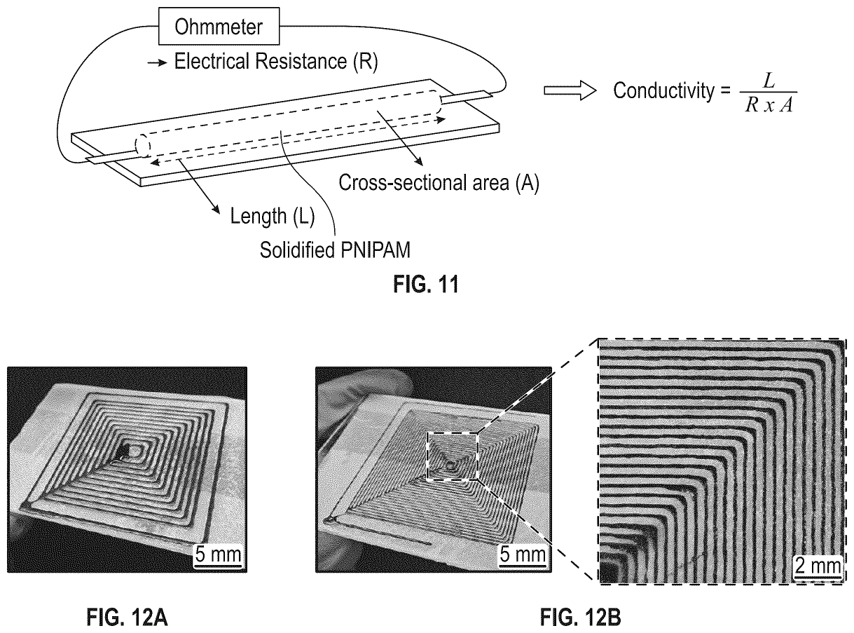

The solidified PNIPAM structures were free-standable overall and could have enhanced mechanical properties and/or conductivity depending on the additive component. For example, the solidified PNIPAM/MXene (FIG. 3J) demonstrated that small particles were instantly entrapped among the aggregated PNIPAM chains in the globule state before diffusing out to the surroundings (FIG. 3K). This instant aggregation was shown as an immediate increase in storage modulus upon contact of the solution with salt ions, and the composite aggregates with stiff particles resulted in higher storage modulus (FIG. 3L). Further, the solidified structure containing MXene and CNT particles demonstrated a higher conductivity than that of the solidified structure of pure PNIPAM (FIG. 3M and FIG. 11) due to the conductive nature of CNT and MXene particles. In the case of the polymer composite, for instance, the solidified PNIPAM/PVA was deformable and stretchable (FIG. 3N), which contrasted with the rigid and non-stretchable structure consisting of the PNIPAM single component. This behavior was likely attributed to the entanglement of PNIPAM and PVA chains and the intrinsically good mechanical properties of PVA (FIG. 30). Indeed, the solidified PNIPAM/PVA in a filament form exhibited good mechanical properties with tensile strength and elastic modulus in the magnitude of 1 MPa and 100 MPa, respectively (FIG. 3P, Q).

### Rheological Characteristics of PNIPAM-Based Solutions

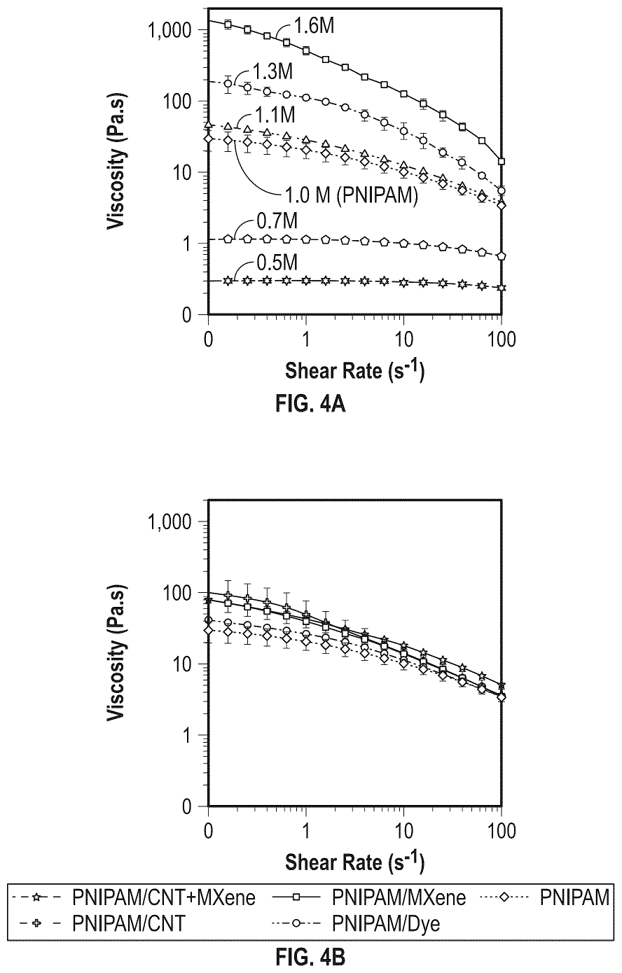

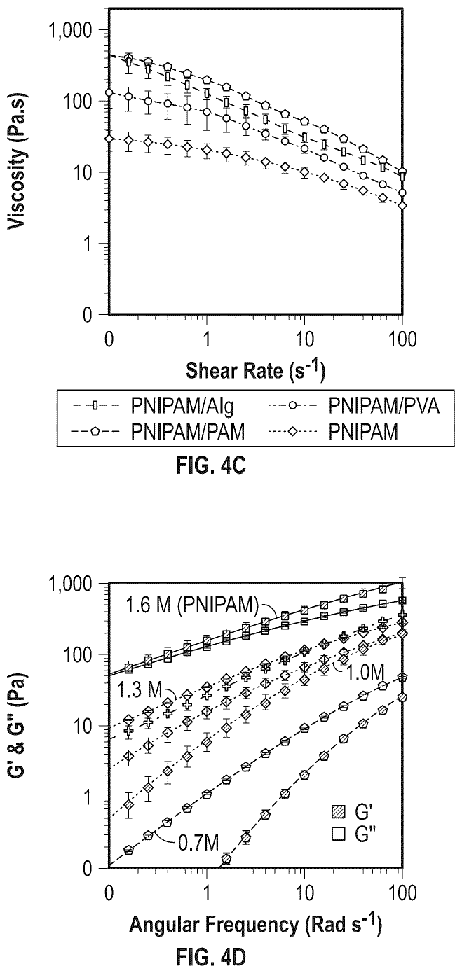

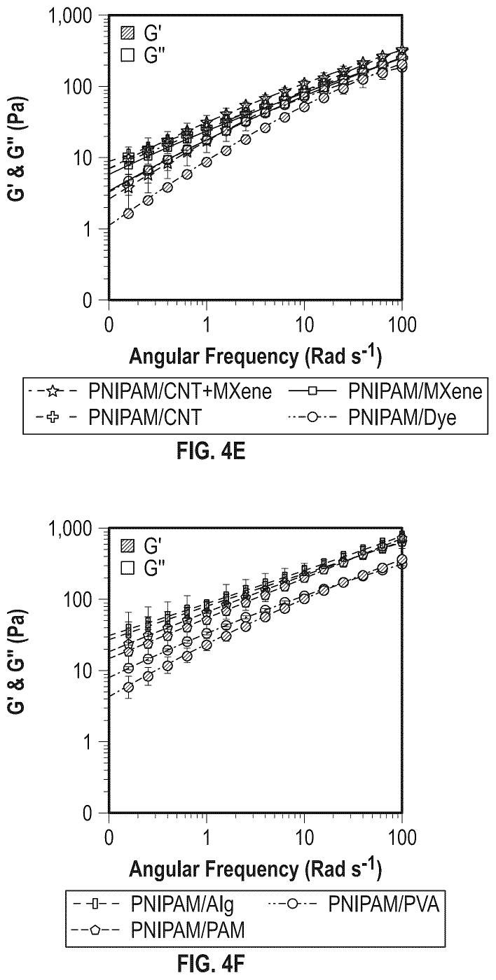

The rheological properties of PNIPAM solutions with a 0.5-1.6M concentration were examined to verify the good extrudability of the PNIPAM solutions (FIG. 4A). As a result, the PNIPAM solutions with a concentration of 1.0M and above exhibited the shear-thinning property that has lower viscosity at high shear rates (i.e., during extruding) and higher viscosity at low shear rates (i.e., after extruding), which indicates that the PNIPAM solution with a certain concentration possesses the proper rheological property for ensuring good printability. To confirm the good extrudability of various PNIPAM composite inks, 1.0M PNIPAM-based composite solutions with Dye, MXene, CNT, PVA, PAM, and Alg, were next prepared respectively, and these solutions exhibited the shear-thinning behavior. The addition of Dye did not considerably affect the solution viscosity, and the MXene or CNT, characterized by their strong and rigid nature, led to an increase in solution viscosity (FIG. 4B). The PNIPAM/polymer composite solutions also exhibited an increased viscosity (FIG. 4C). Nonetheless, all composite solutions possess the shear-thinning property regardless of the presence of additives, fillers, or polymers. The frequency sweep confirmed that PNIPAM solutions were a viscoelastic fluid overall, rather than a stable solid (FIG. 4D). The composite solutions also exhibited the feature of viscoelastic fluid with slightly increased moduli than those of the pure PNIPAM solution (FIG. 4D-F). This result suggests that the PNIPAM viscoelastic solutions (i.e., 1M and above) with appropriate shear moduli and viscosity and shear-thinning behavior can be readily printed without requiring a high-extruding force. Although these solutions were in a state of liquid with G″>G′ unlike typical solid-state printing inks with G′>G″, the spontaneous and instant solidification of PNIPAM-based solutions by the salting-out effect (FIG. 3) allowed us to implement 3D printing without additional rheological modifiers, chemical crosslinkers, postprocessing steps, and specialized equipment.

### Sustainable 3D Printing Utilizing Reversible Salting-Out Effects and its Potential Applications

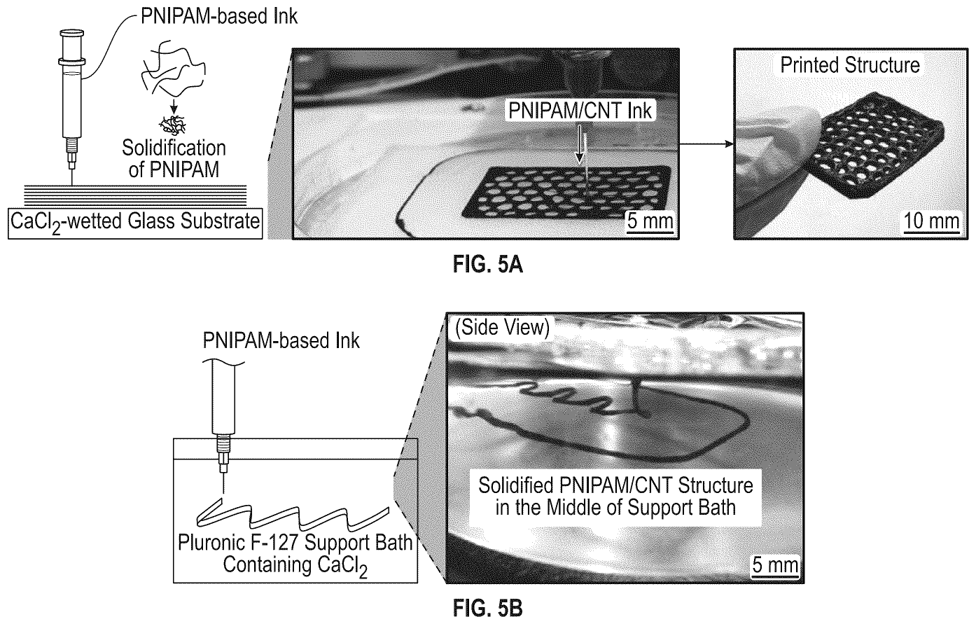

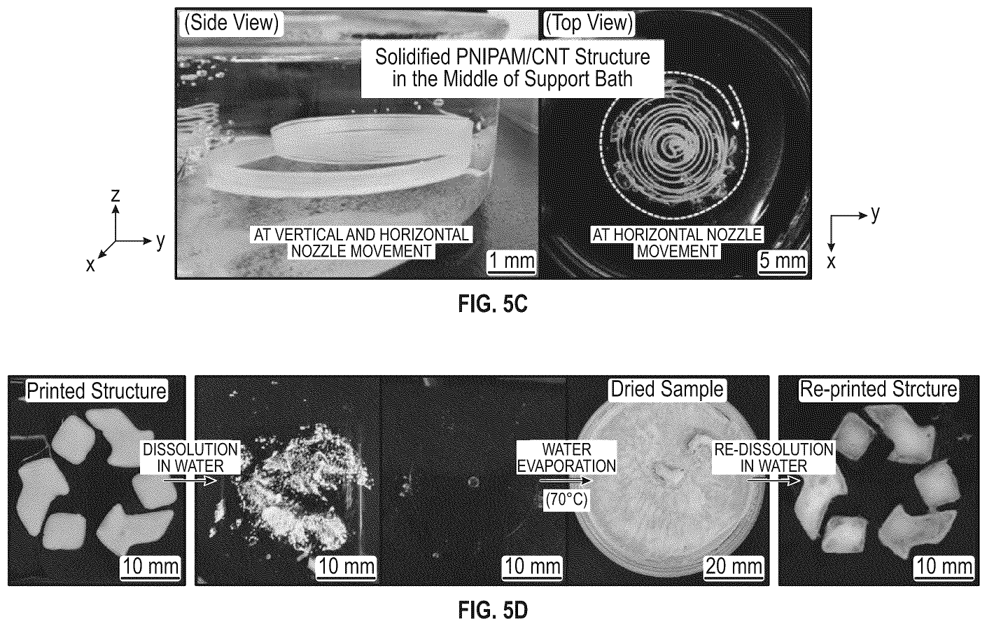

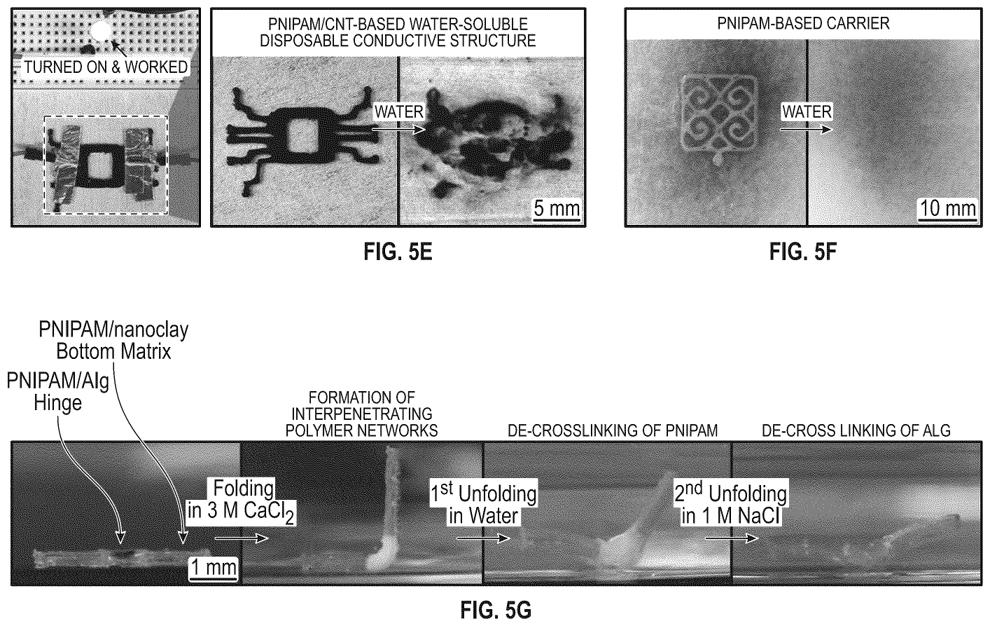

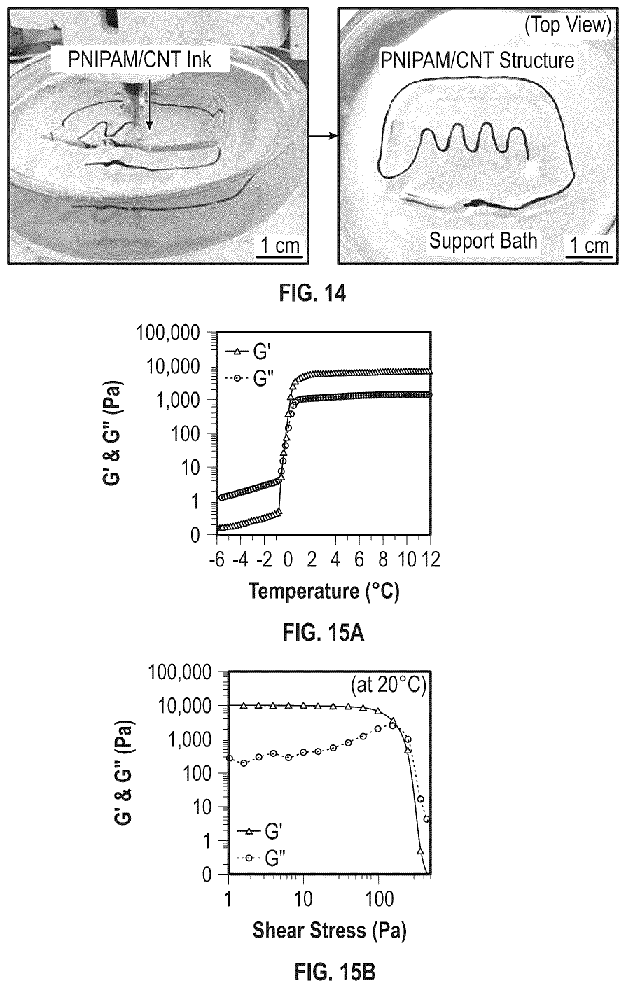

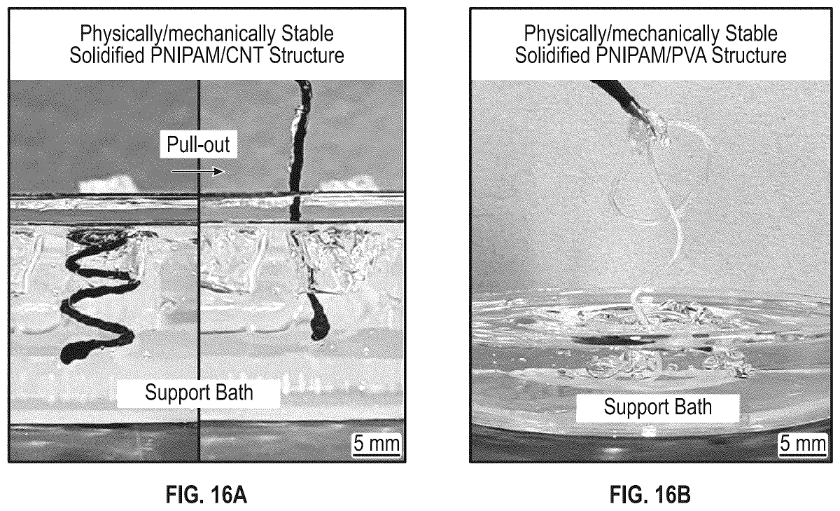

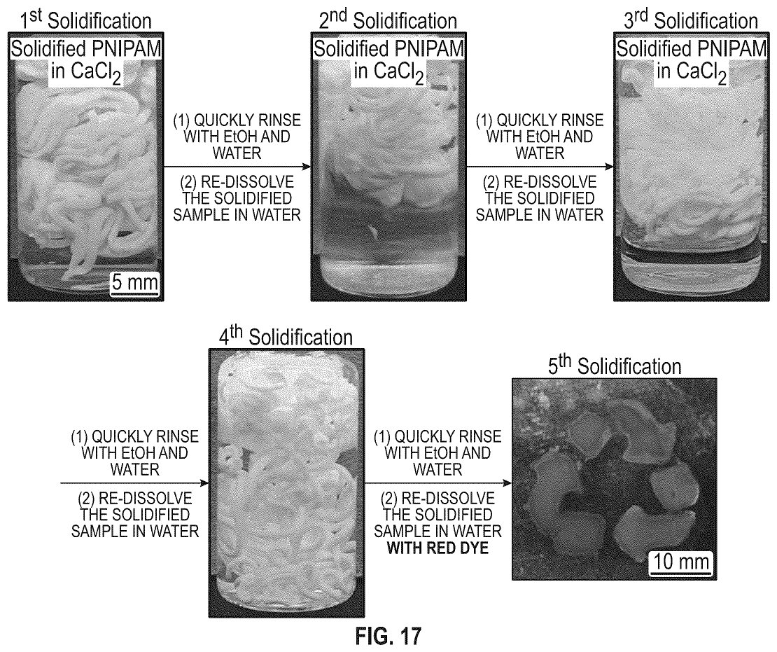

The PNIPAM solutions were applied as 3D printing inks, without rheological modifiers, chemical crosslinkers, or additional postprocessing steps/equipment that are typically required for 3D printing (FIG. 5). The PNIPAM-based solution inks were printed on a salt solution-wetted glass substrate and instantly solidified (FIG. 5A). For example, the resulting printed structure of PNIPAM/CNT remained intact without the need for any post-processing or curing steps (FIG. 5A and FIG. 11). Although a honeycomb-patterned structure was printed with ˜10 layers using a ˜200-μm-diameter nozzle (FIG. 5A), weak layer-layer adhesion between the globule state-aggregated PNIPAM in each layer and intrinsic mechanical limitation of PNIPAM produced mechanically weak solid structures. This could be addressed by using polymer composite solution ink (FIG. 13), such as PNIPAM/PVA forming the entanglement in polymer chains along with intrinsically good mechanical properties of PVA (FIG. 3N-Q). The PNIPAM/PVA solution ink formed firm layer-layer adhesion between the solidified bottom layer containing salt ions and the freshly-printed solution top layer (FIG. 13A-D). As a result, the multi-layered structure was free-standable and stretchable (FIG. 13E, F). Because the PNIPAM-based solution inks exhibited the feature of low viscosity (10-100 Pa s at a shear rate of 0.1 s−1, the state of almost no shear force, FIG. 4A-C) and G′<G″ (FIG. 4D-F and FIG. 13G) unlike conventional printing inks whose viscosity and G′ are in a few kPa-MPa s and larger than G″, respectively, the PNIPAM-based solution inks in extrusion-based 3D printing can be likely suitable for fabricating relatively low-height structures rather than a few cm-scale-height objects. However, the prompt solidification by the salting-out effect allowed for an easy combination with the embedded 3D printing technique that has been known to enable freeform printing omnidirectionally and the printing of complex 3D structures. The extruded solution inks were effectively immobilized and solidified in the middle of the support bath (FIG. 5B, FIG. 14). A physical gel serving as the support bath was prepared using an aqueous blend of Pluronic F-127 and CaCl₂ (FIG. 15). For better visualization, the PNIPAM/CNT solution ink was extruded and immediately solidified upon contact with salt ions dissolved in the support bath; thereby, the printed structure was preserved in the middle of the bath. The PNIPAM/CNT structure that was solidified vertically in a spiral shape could be pulled out from the bath while maintaining its structural stability without failure (FIG. 16A). The PNIPAM/PVA solution ink was also successfully printed and solidified in the middle of the bath at vertical and/or horizontal nozzle movements (FIG. 5C) and could be pulled out from the bath without fracture (FIG. 16B). Air bubbles in the supporting bath surrounding printed structures were formed probably due to the rapid movement of the printing nozzle. These would be minimized through further control of the printing parameter and the rheology of the supporting bath. The recyclability of the PNIPAM solution ink was next investigated (FIG. 5D). The PNIPAM ink was first printed in the shape of a recycle sign onto the flat substrate, and the printed structure was then completely dissolved by simply immersing it in water. Subsequently, the water was evaporated at a 70° C. oven, and thus, a dried PNIPAM was obtained. Finally, this dried material was re-dissolved in water to prepare the recycled ink and used for printing the recycle sign again. PNIPAM recycling was also possible by simply rinsing and dissolution in water without the drying process (FIG. 17). The solidified PNIPAM fully dissolved in water at low temperatures (below the LCST of PNIPAM solidified by salt ions) and then was extruded into a salt solution for solidification. This solidification-dissolution cycle was repeatable. In addition to the fact that PNIPAM is widely recognized as a non-cytotoxic, non-genotoxic, and biocompatible material, this recycling of the PNIPAM solution, which consists of straight forward dissolution, collection, and re-printing procedures, demonstrates the potential for implementing an environmentally sustainable 3D printing.

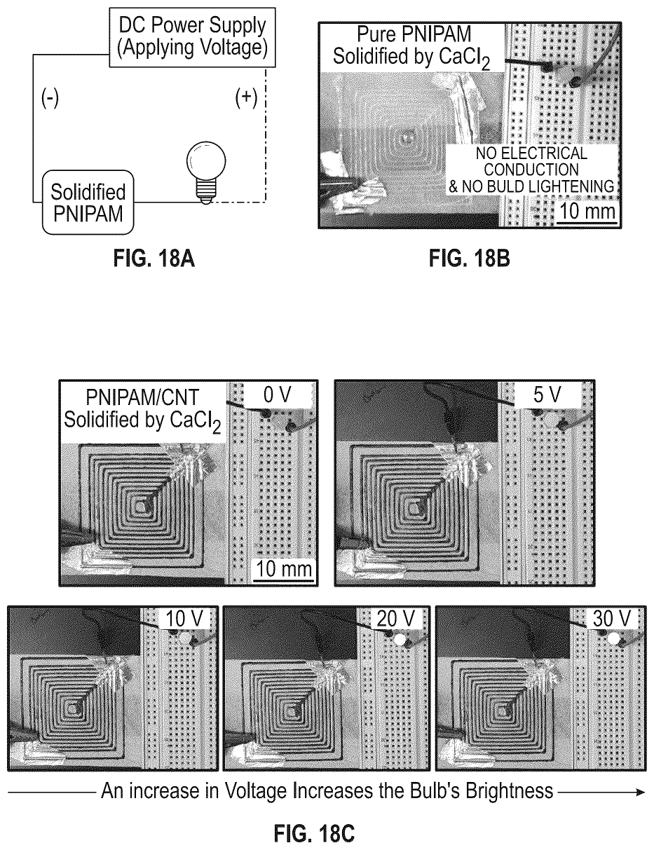

The PNIPAM/CNT solution was applicable for printing water soluble disposable conductive structures (FIG. 5E and FIG. 18). The printed and dried pure PNIPAM structure failed to enable light-bulb functioning due to the lack of electrical conduction in pure PNIPAM (FIG. 18B). In contrast, the electrical conduction through the CNTs in the PNIPAM/CNT structure, which was printed and dried, enabled a light bulb to function. Such results suggest that the PNIPAM/CNT solution ink can be used for fabricating printable electrical circuits. The brightness of this bulb gradually increased with increasing voltage from 0 to 30 V, reaching its maximum at 25-30 V (FIG. 18C). In this demonstration, 10% CNTs were incorporated in the printed structure, and the resulting printed structure was compatible with a 25-30 V. Further studies (e.g., with different conductive particle contents) could possibly reduce the compatible voltage of the electric circuit/electrode-array for advanced electrical devices connecting with low-voltage batteries. Meanwhile, because this printed structure comprising physically crosslinked PNIPAM was water-soluble, it demonstrates promise for developing disposable yet environmentally friendly electrically conductive structures (FIG. 5E). Moreover, the water-soluble printed structure can be utilized as a carrier delivering small particles/molecules. For example, a red dye-loaded PNIPAM structure was transferred to another substance through a simple environmental change, in this case, exposure to water (FIG. 5F). Subsequently, the dye was released upon dissolving the PNIPAM.

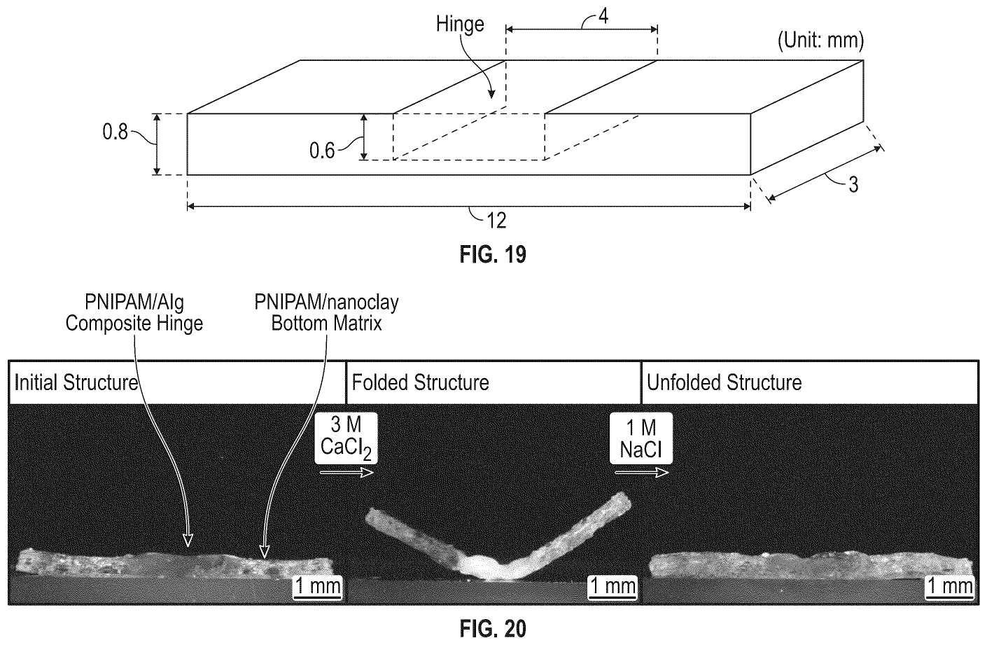

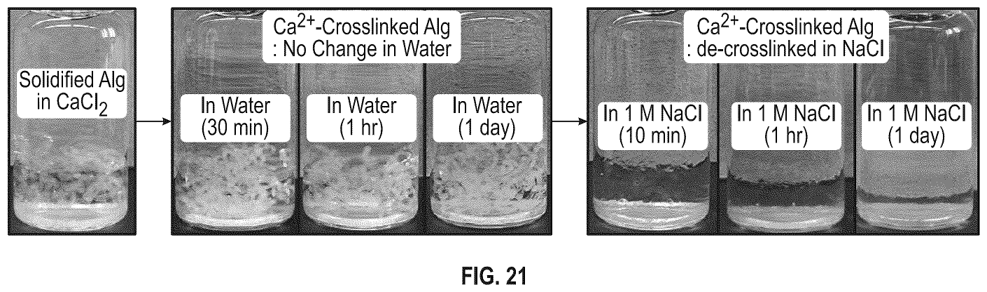

Furthermore, the PNIPAM/Alg solution was applicable for realizing multi-stage actuators that exhibit multiple folding angles when subjected to a solution of different salt types and concentrations. A soft actuator, which comprised a PNIPAM/nanoclay bottom matrix and a PNIPAM/Alg hinge (FIG. 19), demonstrated a significant fold of nearly 90° when immersed in a 3 M CaCl₂ solution, transitioning from its unfolded as-prepared state) (180°) (FIG. 5G). This self-folding was mainly attributed to the strain mismatch between the bottom matrix and the hinge due to the significant volume contraction of the PNIPAM/Alg hinge upon the solidification by salt ions. Subsequently, the actuator was slightly unfolded from ˜90° to 115° in water, resulting from the de-crosslinking of physically crosslinked PNIPAM chains, followed by being almost unfolded in a 1 M NaCl solution caused by the de-crosslinking of Alg networks triggered by Na+ ions. This multi-stage actuator was also unfolded through a single stage in a 1 M NaCl solution without a step of soaking in water (FIG. 20) because the 1 M NaCl solution simultaneously de-crosslinked both the Ca²⁺-crosslinked Alg (FIG. 21) and the aggregated PNIPAM chains with physical crosslinks due to the increase in the LCST of PNIPAM (˜25° C., FIG. 2E). This controllable multi- or single-stage actuation mechanism by water-salt demonstrates another applicability of the reversible salting-out effects.

### Conclusions

This study demonstrated that immediate aggregation of PNIPAM chains upon contact with a salt solution allowed extrusion-based 3D printing. From the perspective of interchain bonding formation, previous studies also showcased the solidification of extruded inks due to the formation of supramolecular interactions, polyelectrolyte complexes, or ionic crosslinks, upon contact with a certain medium. Such interchain interactions were formed in the extruded ink or between the ink and medium. Note that discussion on typical methods requiring post-processing steps for solidification, such as chemical crosslinking under heat or light for solidification is excluded. In particular, the formation of polyelectrolyte complexes between polyelectrolyte chains with different anionic and cationic groups upon contact with water or alcohol-water mixture can be analogous to the mechanism responsible for the formation of intermolecular hydrophobic interactions in the globule state of PNIPAM by salt ions. In contrast to the previous studies, the distinctiveness of the salting-out-based solidification strategy lies in its applicability to various PNIPAM-based composite solutions with functional particles (i.e., hydrophilic and/or hydrophobic additives) or polymeric materials. The functional particles and polymers were well mixed with the PNIPAM solution, and the PNIPAM-based composite solutions exhibited proper rheological properties and good printability. Moreover, the salting-out-based solidification was applicable to implement embedded 3D printing. The printing of PNIPAM-based solution ink inside a support bath with dissolved salt ions demonstrated the fabrication of the stable 3D solid structure.

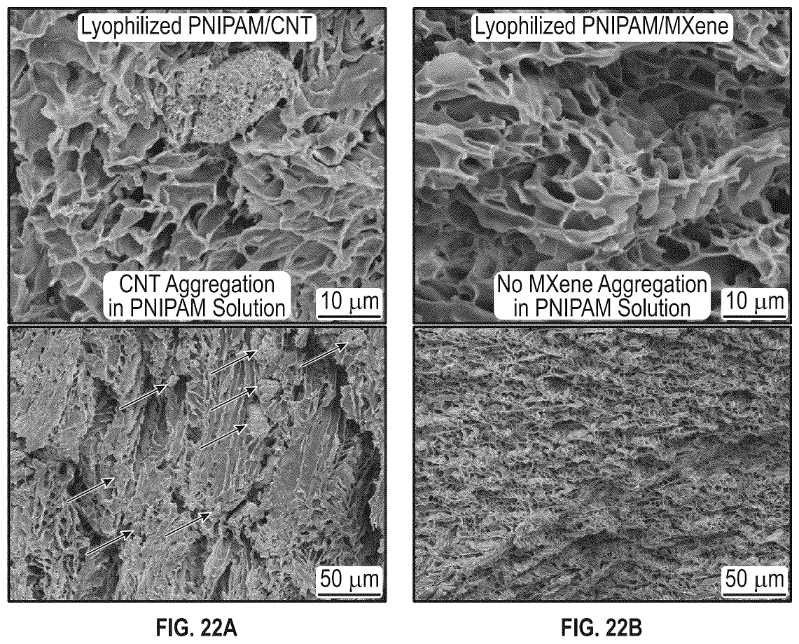

In summary, salt solutions have been utilized to lower the LCST of PNIPAM, thus forming physical crosslinks among PNIPAM chains spontaneously (i.e., the salting-out effect on PNIPAM). This led to immediate solidification of the PNIPAM solution while printing at ambient temperatures (e.g., 20-25° C.). The PNIPAM solution and various PNIPAM-based composite solutions containing functional additives or polymeric materials were readily printable through syringe needles and solidified rapidly upon contact with salt ions, without requiring rheological modifiers, chemical crosslinkers, or additional post-processing steps/equipment. Furthermore, the reversible physical crosslinking and de-crosslinking of polymers via the salting-out effect facilitated the recycling of the PNIPAM solution ink, demonstrating the potential for implementing sustainable 3D printing. Such an unprecedented printing approach using the PNIPAM-based system demonstrated strong potential for a wide range of applications, for instance, in the development of a water-soluble disposable recyclable electric circuit, a smart carrier for material delivering, and a multi-stage soft actuator capable of responding to environmental changes in salt concentrations on demand without requiring chemical modifications or compatibility constraints. In terms of electrically conductive structures, further studies could be conducted on the effect of the content of conductive particles (e.g., CNT and MXene particles) and on the way of obtaining homogeneous conductive PNIPAM solutions (FIG. 22) to increase electrical conductivity for advanced electrical devices (e.g., bioelectronics). This technique, employing reversible physical crosslinking and de-crosslinking of polymers through the salting-out effect, has contributed to the expansion of environmentally friendly polymer manufacturing technologies, encompassing 3D printing methodologies, recyclable polymeric devices, and smart actuators/sensors.

### Exemplary Aspects

The following exemplary clauses are provided, the numbering of which is not to be construed as designating levels of importance:

Clause 1. A method for additive manufacturing, comprising: placing a polymer solution comprising a polymer susceptible to solidification due to salting-out effects into contact with a salt solution; inducing solidification of the polymer through salting-out effects; and removing the solidified polymer from the salt solution, or a mixture thereof.

Clause 2. The method of clause 1, wherein the polymer comprises a protein, DNA, a polyacrylamide.

Clause 3. The method of clause 1, wherein the polymer comprises poly(N-isopropylacrylamide) (PNIPAM), a PNIPAM-based copolymer, or a mixture thereof.

Clause 4. The method of clause 1, wherein the salt solution comprises a kosmotropic salt, a chaotropic salt, or a mixture thereof.

Clause 3. The method of clause 1, wherein the polymer solution further comprises a functional material comprising a dye, a non-conductive particle, a conductive particle, a different polymer, or a mixture thereof.

Clause 4. The method of clause 3, wherein the non-conductive particle comprises aluminum oxide (Al2O3), boron nitride (BN), mica, illite, magnesium hydroxide (Mg(OH)₂), aluminum nitride (AlN), boron carbide (B4C), Mg—Al-based layered double hydroxide, Ca—Al-based layered double hydroxide, Li—Al-based layered double hydroxide, or a combination thereof.

Clause 5. The method of clause 3, wherein the conductive particle comprises an active carbon, carbon nanotube (CNT), boron nitride, graphite, graphite oxide, graphene, graphene oxide, MXene, or a combination thereof.

Clause 6. The method of clause 3, wherein the different polymer comprise alginate (Alg), polyethylene glycol (PEG), chitosan, gelatin, polyacrylic acid (PAA), polyacrylamide (PAM), agar, poly(2-acrylamido-2-methylpropanesulfonic acid) (PAMPS), polyvinyl alcohol (PVA), polyethylene (PE), polyvinyl chloride (PVC), polypropylene (PP), polyurethane (PU), polyvinylpyrrolidone (PVP), poly(3,4-ethylenedioxythiophene) (PEDOT), polythiophene (PT), polypyrrole (PPy), polyaniline (PANI), polythiophene (PTh), poly(p-phenylene sulfide) (PPS), or a mixture thereof.

Clause 7. The method of clause 1, wherein the salt solution comprises a salt ion selected from the group comprising CO32−, SO42−, S2O32−, HPO42−, H2PO4−, F—, Cl—, Br—, NO3−, I—, ClO4−, SCN—, Na+, K+, Li+, Ba2+, Ca2+, Zn2+, Fe2+, Fe3+, Mg2+, Cu2+, Sr2+, Co2+, Mn2+, Ni2+, Sn2+, Zn2+, Al3+, Ga3+, Ti3+, or a combination thereof.

Clause 8. The method of clause 1, wherein the method is performed at a temperature in a range of from about 20° C. to about 30° C.

Clause 9. The method of clause 1, wherein the method is performed at a temperature in a range of from about 23° C. to about 27° C.

Clause 10. The method of clause 1, wherein the placing the polymer solution into contact with the salt solution comprises dispensing the polymer solution into a container comprising the salt solution.

Clause 11. The method of clause 10, wherein the polymer solution is extruded using a syringe or/and printing head, or through a printer.

Clause 12. The method of clause 10, wherein the syringe and printing head are moved along a predetermined pattern.

Clause 13. The method of clause 12, wherein the predetermined pattern is supplied by a computer-aided design file.

Clause 14. The method of clause 13, wherein the computer-aided design file is a two-dimensional pattern, a three-dimensional pattern, or a combination thereof.

Clause 15. The method of clause 10, wherein the container comprises a mask to selectively limit contact between the polymer solution and the salt solution.

Clause 16. The method of clause 10, wherein the container comprises a bed movable in a vertical direction, horizontal direction, or both.

Clause 17. The method of clause 1, further comprising treating the solidified polymer.

Clause 18. The method of clause 17, wherein treating the solidified polymer comprises coating the solidified polymer, functionalizing the solidified polymer, or a combination thereof.

Clause 19. The method of clause 18, wherein coating the solidified polymer comprises coating the solidified polymer with a silicone compound.

Clause 20. The method of clause 1, further comprising contacting the solidified polymer with water to dissolve the solidified polymer.

Clause 21. The method of clause 1, further comprising contacting a solution comprising the dissolved polymer with the salt solution.

Clause 22. The method of clause 1, wherein a concentration of ions in the salt solution is in a range of from about 0.05 M to about 4.00 M.

Clause 23. The method of clause 1, wherein a concentration of ions in the salt solution is in a range of from about 0.3 M to about 3.0 M.

Clause 24. The method of clause 1, wherein the polymer solution further comprises a therapeutic agent, a self-healing polymer, a shape memory polymer, a surfactant, an antimicrobial particle, a photonic crystal, a magnetic particle, a thermally conductive particle, a pore-forming agent, an acoustic metamaterial, a wetting agent, an adhesive polymer, a lubricant, or a mixture thereof.

Clause 25. A structure formed according to the additive manufacturing method of clause 1.

Clause 26. The structure of clause 25, wherein the structure comprises a plurality of layers arranged horizontally, vertically, or both with respect to one another.

Clause 29. The structure of clause 26, wherein the structure is an electrical circuit, energy storage device, actuator, soft robot, support structures or combinations thereof.

What is claimed is:

1. A method for additive manufacturing, comprising:
placing a polymer solution comprising a polymer susceptible to solidification due to salting-out effects into contact with a salt solution;
inducing solidification of the polymer through salting-out effects; and
removing the solidified polymer from the salt solution, or a mixture thereof.

2. The method of claim 1, wherein the polymer comprises a protein, DNA, a polyacrylamide, or a mixture thereof.

3. The method of claim 1, wherein the polymer comprises poly(N-isopropylacrylamide) (PNIPAM), a PNIPAM-based copolymer, or a mixture thereof.

4. The method of claim 1, wherein the salt solution comprises a kosmotropic salt, a chaotropic salt, or a mixture thereof.

5. The method of claim 1, wherein the polymer solution further comprises a functional material comprising a dye, a non-conductive particle, a conductive particle, a different polymer, or a mixture thereof.

6. The method of claim 5, wherein the non-conductive particle comprises aluminum oxide (Al₂O₃), boron nitride (BN), mica, illite, magnesium hydroxide (Mg(OH)₂), aluminum nitride (AlN), boron carbide (B₄C), Mg—Al-based layered double hydroxide, Ca—Al-based layered double hydroxide, Li—Al-based layered double hydroxide, or a combination thereof.

7. The method of claim 5, wherein the conductive particle comprises an active carbon, carbon nanotube (CNT), boron nitride, graphite, graphite oxide, graphene, graphene oxide, MXene, or a combination thereof.

8. The method of claim 1, wherein the method is performed at a temperature in a range of from about 20° C. to about 30° C.

9. The method of claim 1, wherein the method is performed at a temperature in a range of from about 23° C. to about 27°° C.

10. The method of claim 1, wherein the placing the polymer solution into contact with the salt solution comprises dispensing the polymer solution into a container comprising the salt solution.

11. The method of claim 10, wherein the polymer solution is extruded using a syringe or/and printing head, or through a printer.

12. The method of claim 10, wherein the syringe and printing head are moved along a predetermined pattern.

13. The method of claim 12, wherein the predetermined pattern is supplied by a computer-aided design file.

14. The method of claim 13, wherein the computer-aided design file is a two-dimensional pattern, a three-dimensional pattern, or a combination thereof.

15. The method of claim 10, wherein the container comprises a mask to selectively limit contact between the polymer solution and the salt solution.

16. The method of claim 10, wherein the container comprises a bed movable in a vertical direction, horizontal direction, or both.

17. The method of claim 1, further comprising treating the solidified polymer.

18. The method of claim 17, wherein treating the solidified polymer comprises coating the solidified polymer, functionalizing the solidified polymer, or a combination thereof.

19. The method of claim 18, wherein coating the solidified polymer comprises coating the solidified polymer with a silicone compound.

20. The method of claim 1, further comprising contacting the solidified polymer with water to dissolve the solidified polymer.
